(19) United States
(12) Patent Application Publication
(10) Pub. No.: US 2011/0090818 A1
(43) Pub. Date: Apr. 21, 2011

(54) COMMUNICATION SYSTEMS AND METHOD

(75) Inventor: Glenroy J. Alexis, Ellicott City, MD (US)

(73) Assignee: XCELIS COMMUNICATIONS, LLC, Chalfont, PA (US)

(21) Appl. No.: 12/978,925

(22) Filed: Dec. 27, 2010

Related U.S. Application Data
(62) Division of application No. 11/171,474, filed on Jul. 1, 2005.
Application No. 11/171,474 is a continuation-in-part of application No. 10/615,408, filed on Jul. 9, 2003, now abandoned.
Application No. 10/615,408 is a continuation-in-part of application No. 10/359,277, filed on Feb. 6, 2003, now Pat. No. 7,565,115.
(60) Provisional application No. 60/584,131, filed on Jul. 1, 2004.
(60) Provisional application No. 60/394,283, filed on Jul. 9, 2002.
(60) Provisional application No. 60/457,332, filed on Mar. 26, 2003.
(60) Provisional application No. 60/394,283, filed on Jul. 9, 2002.

(51) Int. Cl. H04W 84/00; H04W 4/16

(52) U.S. Cl. 370/254; 370/328

(57) ABSTRACT

An example system includes one or more handsets and a base unit including interface circuitry. The interface circuitry is configured for landline communication over a telephone network landline, wireless communication with the one or more handsets and wireless communication with one or more cellular telephones, each of the one or more cellular telephones being adapted for communication over a cellular telephone network. The interface circuitry is further configured to allow the handsets to make or receive landline or cell phone calls.

### CROSS-REFERENCE TO RELATED APPLICATIONS

This application is a divisional of application Ser. No. 11/171,474 filed Jul. 1, 2005, which claims the benefit of Application No. 60/584,131 filed on Jul. 1, 2004 and which is a continuation-in-part of application Ser. No. 10/615,408 filed on Jul. 9, 2003, which claims the benefit of provisional Application Nos. 60/394,283 filed on Jul. 9, 2002 and 60/457,332 filed on Mar. 26, 2003 and which is a continuation-in-part of application Ser. No. 10/359,277 filed on Feb. 6, 2003 (now U.S. Pat. No. 7,565,115), which claims the benefit of provisional Application No. 60/394,283 filed on Jul. 9, 2002.

The contents of each of the aforementioned applications are incorporated herein in their entirety.

### BACKGROUND AND SUMMARY

The subject patent application generally relates to communication systems and methods.

Mobile communication devices such as mobile telephones are becoming more and more popular. As such, it is desirable to provide systems and methods that provide additional functionalities and capabilities for these devices.

By way of example, but not by way of limitation, this application describes a system and method of placing a landline call in which a call is placed from a first wireless communication device to a second wireless communication device. The second wireless communication device is connected to a landline to provide a landline connection for the first wireless communication device via the second wireless communication device. A call from the first wireless communication device can be placed over the landline.

By way of further example, but not by way of limitation, this application describes a system and method of placing an Internet call in which a call is placed from a first wireless communication device to a second wireless communication device. The second wireless communication device is connected to the Internet to provide an Internet connection for the first wireless communication device via the second wireless communication device. A call from the first wireless communication device can be placed over the Internet.

By way of still further example, but not by way of limitation, this application describes a system and method for placing a landline call from a wireless communication device adapted for communication over a wireless communication network. A wireless short-distance communication link is established between the wireless communication device and an access point coupled to the landline. A call may be placed from the wireless communication device over the landline using the short-distance communication link to the access point.

By way of still further example, but not by way of limitation, this application describes a system and method for placing an Internet call from a wireless communication device adapted for communication over a wireless communication network. A wireless short-distance communication link is established between the wireless communication device and an access point coupled to the Internet. A call may be placed from the wireless communication device over the Internet using the short-distance communication link to the access point.

By way of still further example, but not by way of limitation, this application describes a system and method for providing content to a wireless mobile communication device. The same identifier is assigned to a plurality of wireless access points and the wireless mobile communication device is paired to the wireless access points using the identifier. Content is sent to the mobile wireless communication device from one or more of the wireless access points.

### BRIEF DESCRIPTION OF THE DRAWINGS

FIG. 1 is a generalized block diagram of an example communication system;

FIG. 2A is a circuit block diagram of one example of interface circuitry for use in the system of FIG. 1;

FIG. 2B is a detailed schematic showing the interconnections of the various switches in the example interface circuitry shown in FIG. 2A;

FIG. 2C is a circuit block diagram of another example of interface circuitry for use in the system of FIG. 1;

FIG. 3 is a table summarizing the states of the switches in the example interface circuitry 106 shown in FIG. 2A;

FIG. 4 is a generalized block diagram of another example communication system;

FIG. 5 is a circuit block diagram of one example of interface circuitry for use the system of FIG. 4;

FIG. 6 is a circuit block diagram of another example of interface circuitry for use in the system of FIG. 4;

FIG. 7 shows an example adapter-equipped wireless communication device for use in the system of FIG. 4;

FIG. 8 shows the components of adapter circuitry of FIG. 7 incorporated in a housing;

FIG. 9 shows an example wireless transceiver module;

FIG. 10 is an example of a system in which multiple satellite handsets are associated with a single base station;

FIG. 11 is a generalized diagram for explaining how wireless calls can be placed and received using cordless handsets;

FIG. 12 is a diagram of the system of FIG. 11 showing an example base station;

FIGS. 13A and 13B show example systems in which internet and/or landline calls may be placed and received by a remote mobile telephone;

FIG. 14 shows an example arrangement permitting a Bluetooth-enabled mobile phone to place VoIP calls;

FIG. 15 shows an example arrangement permitting a Bluetooth-enabled mobile phone to place and receive landline calls;

FIG. 16 shows an example arrangement permitting a Bluetooth-enabled mobile phone to place internet calls via a computer;

FIG. 17 shows an example system in which content may be delivered to mobile devices via distributed access points;

FIGS. 18A and 18B show the interface circuitry of FIG. 2C incorporated in a housing; and

FIGS. 19A and 19B show example access points for use in the system of FIG. 17.

### DETAILED DESCRIPTION OF EXAMPLE EMBODIMENTS

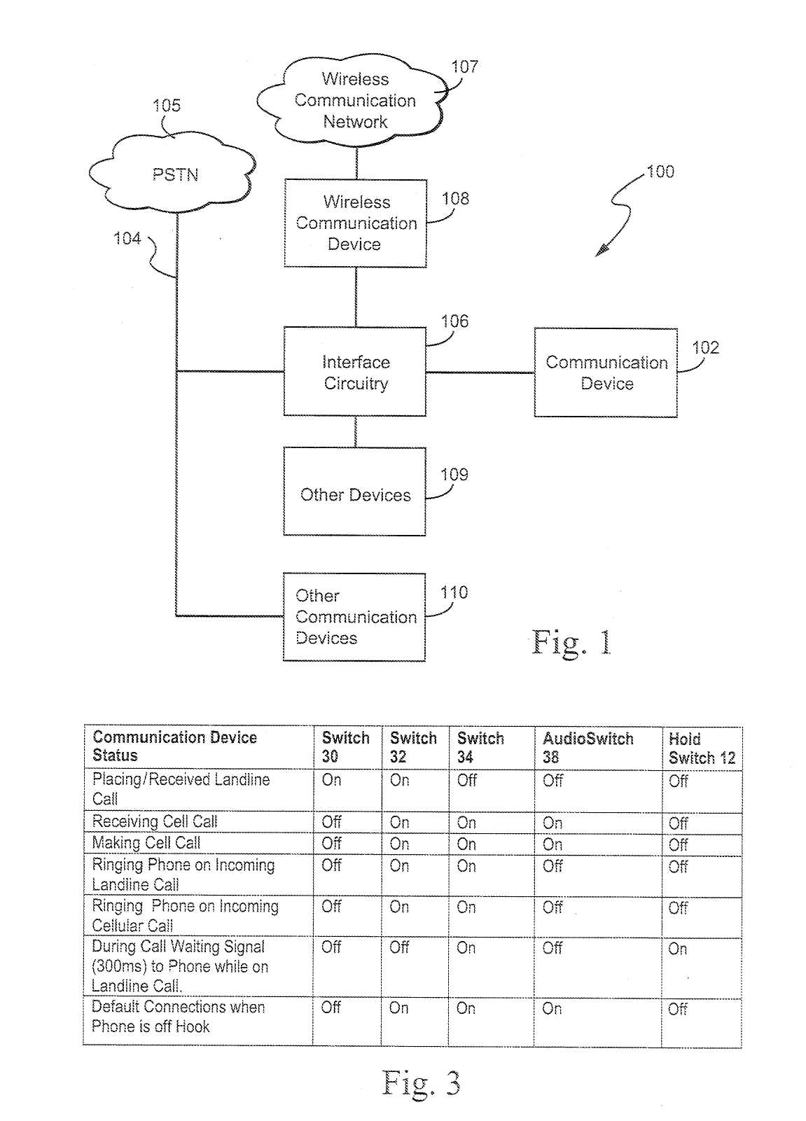

FIG. 1 is a generalized block diagram of an example communication system 100. Communication system 100 includes a communication device 102 connected via interface circuitry 106 to a ring-tip line pair 104 for landline calls over the PSTN 105. As is well known, PSTN 105 includes a hierarchy of telephony switching offices. For example, individual subscribers are connected to a nearby telephone exchange, sometimes referred to as an end office or switching office; the switching office is connected to a local central office; the local central office is connected to a toll office; the toll office is connected to a primary telephony center; and the primary telephony center is connected to a sectional telephony center. Sectional telephony centers are connected to regional telephony centers, which typically are the highest level in the PSTN 105 switching hierarchy. Other communication devices 110 may also be connected to line pair 104. The communication devices 102, 110 may be any communication devices that are configured for communication over PSTN 105 such as telephones, computer systems, facsimile machines, set-top boxes, personal video recording devices, etc.

Interface circuitry 106 is also connected to a wireless communication device 108 for a wireless communication network 107. Wireless communication network 107 may be for any conventional wireless service such as analog advanced mobile phone service (AMPS), digital advanced mobile phone service (D-AMPS), global system for mobile communications (GSM), personal communication service (PCS), satellite service (including low earth-orbiting satellites), specialized mobile radio (SMR), cellular digital packet data (CDPD), Wideband Code Division Multiple Access (WCDMA), 3G, and CDMA2000. A cellular communication network, for example, is made up of cells, each of which includes at least radio transmitter/receiver with which a cellular communication device can communicate. Under the control of a switching office, the radio transmitter/receiver with which the cellular communication device communicates changes as the cellular communication device moves from one cell to another. Example cellular communication devices include cellular telephones and cellular personal digital assistants (PDAs).

In the following description, communication devices 102 and 108 are sometimes referred to as telephones. However, use of the term “telephone” in a particular instance is not intended to exclude the possibility of using other communication devices.

Among other things, interface circuitry 106 permits both landline calls via PSTN 105 and wireless calls via wireless communication network 107 to be placed and received using communication device 102. The other communication devices 110 connected to the same landline 104 as communication device 102 may be used for landline calls even if communication device 102 is being used to place or receive a wireless call because, during a wireless call, communication device 102 is physically disconnected from landline 104 and is connected to the wireless communication device 108 via interface circuitry 106. As will be discussed in greater detail below, the interface circuitry is configured so that if communication device 102 is engaged in a wireless call, that wireless call may be placed on hold to answer an incoming landline call via PSTN 105. Likewise, if the communication device 102 is engaged in a landline call, that landline call may be placed on hold to answer an incoming wireless call via wireless communication network 107. Wireless and landline calls can also be conferenced together.

Communication system 100 may also include other devices 109 connected to interface circuitry 106. For example, such devices may be output devices for outputting information received via the wireless communication system. These devices may include a television, a monitor, a facsimile machine, a printer and the like. These other devices 109 may be connected by wire or wirelessly to interface circuitry 106.

To make a call over PSTN 105 from communication device 102, a user first inputs a predetermined code (e.g., “#”) to the communication device. For example, if the communication device is a telephone, the user may press certain buttons on the keypad of the telephone. Among other things, this code results in interface circuitry 106 connecting communication device 102 to line pair 104. Thereafter, the user can simply dial the number of the called party.

To make a call over the wireless communication network from communication device 102, the user simply dials the number of the called party and enters a predetermined code (e.g., “#”) when dialing is finished. When the predetermined code is entered at the end of the called party's number, interface circuitry 106 provides the dialed number to the wireless communication device, which then dials the number to place the call.

As an alternative or in addition to determining how to place a call based on the inputting of predetermined codes, the interface circuitry may automatically determine whether to place a call from communication device 102 via PSTN 105 or wireless communication network 107. For example, if one of the other communication devices 110 is already on a landline call, interface circuitry 106 may detect this condition and automatically place any call from communication device 102 over wireless communication network 107 using wireless communication device 108. Interface circuitry 106 may also determine whether to place a particular call from communication device 102 over PSTN 105 or over wireless communication network 107. This determination may, by way of illustration, be based on cost. For example, some monthly cellular telephone plans provide for low cost long-distance calls at certain times such as evenings and weekends. If wireless communication device 108 is a cellular telephone connected to a cellular telephone network, interface circuitry 106 may therefore be configured with intelligence (e.g., real time clock to determine time that a call is placed, a memory storing calling rates, etc.) to place long distance calls from communication device 102 over the cellular communication network via the cellular telephone at these times.

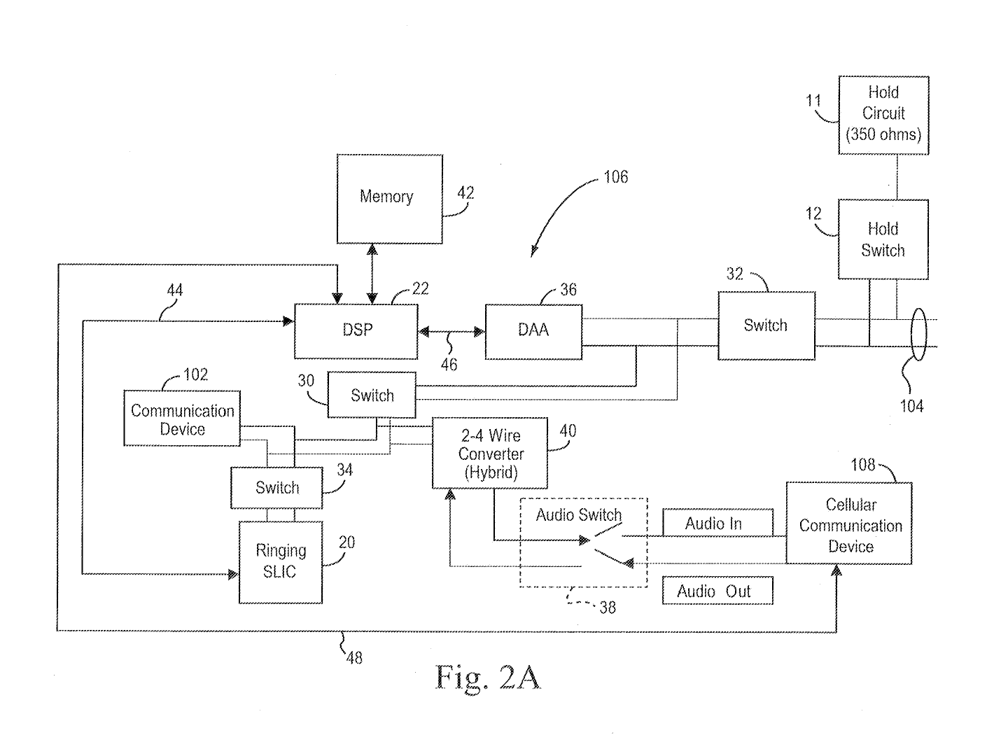

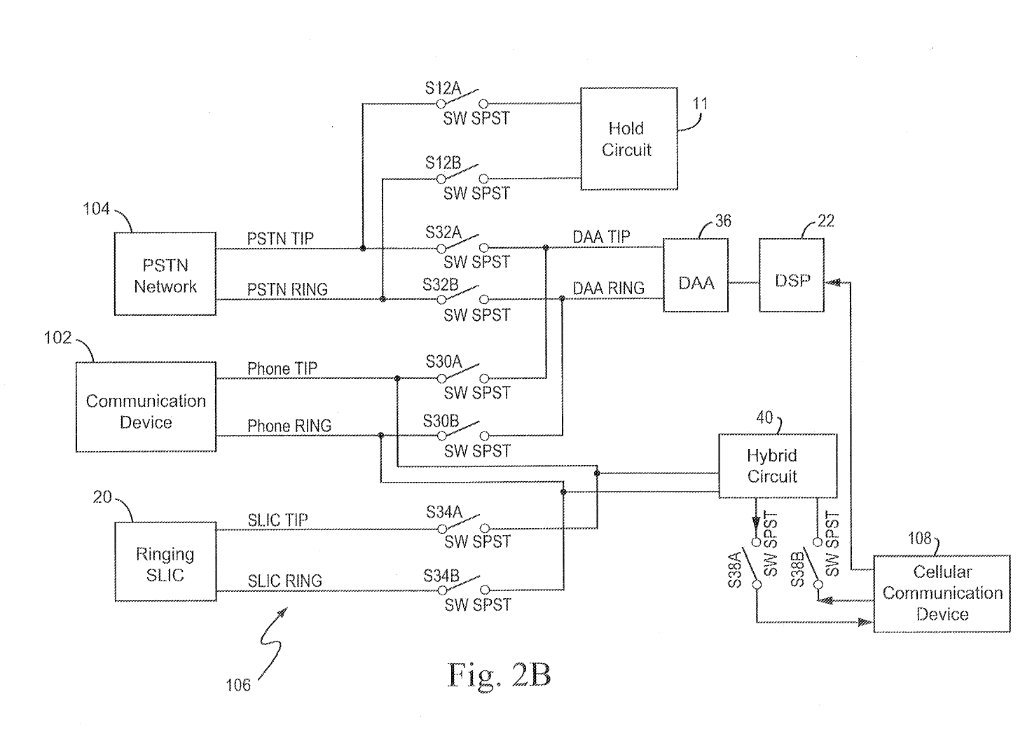

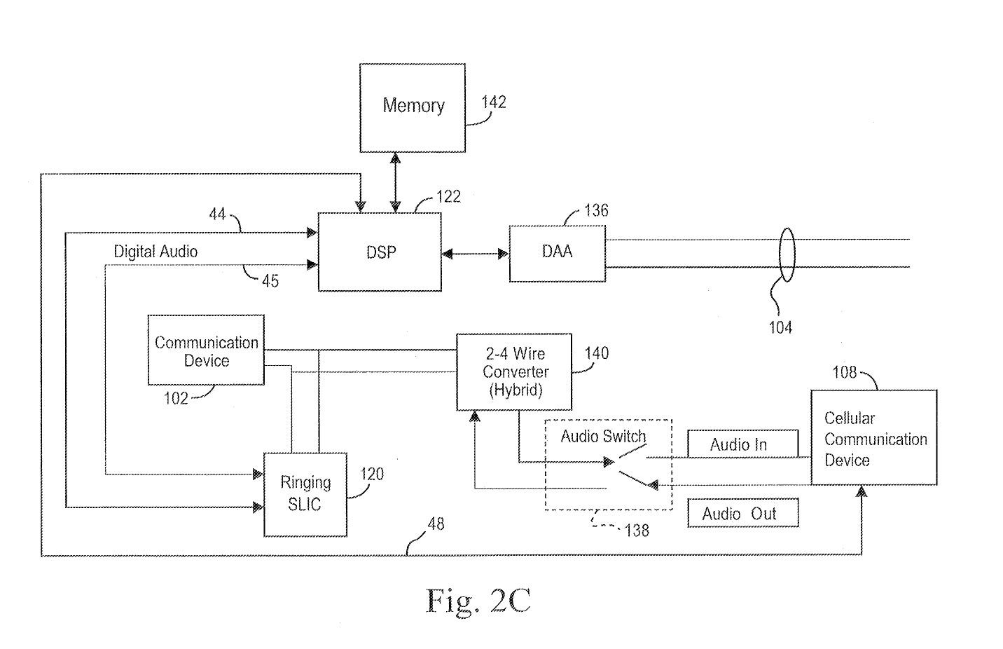

FIG. 2A is a circuit block diagram of one example of interface circuitry 106. In FIG. 2A, wireless communication device 108 is a cellular device and wireless network 107 is a cellular network. It will of course be appreciated that the following description is applicable to any of the wireless devices and services mentioned above. Line pair 104 provides DC current (e.g., to power electronics of the communication device 102), AC current to ring the telephone bell, and a full duplex communication path. A hold circuit 11 is selectively connected via a hold switch 12 across the tip-ring pair to place a call on hold without disconnecting the call. Hold circuit 11 may, for example, comprise a 350-ohm resistor. Communication device 102 is connected to line pair 104 via first and second switches 30, 32.

The interface circuitry also includes a ringing Subscriber Line Interface Circuit (SLIC) 20 that performs a variety of functions. Ringing SLIC 20 detects and decodes Dual Tone Multi-Frequency (DTMF) codes generated by communication device 102 and communicates these codes to Digital Signal Processor (DSP) 22. Ringing SLIC 20 creates and generates standard and custom telephone signals and tones such as busy signals, dial tones, and the like, and also rings the communication device 102 when there is an incoming call from PSTN 105 or cellular communication network 107. Specifically, DAA 36 detects incoming calls via line pair 104 and provides an incoming landline call signal to DSP 22. In response to this signal, DSP 22 causes ringing SLIC 20 to ring communication device 102. Similarly, DSP 22 detects incoming calls to cellular communication device 108 via its connection thereto over bus 48. In response to this detection, DSP 22 causes ringing SLIC 20 to ring communication device 102. Ringing SLIC 20 may provide different rings to distinguish between incoming cellular and landline calls. Ringing SLIC 20 also generates analog signals used, for example, to send information such as CID (Caller ID) data to communication device 102. In addition, because communication device 102 is only selectively connected to line pair 104, an integrated DC-DC converter of ringing SLIC 20 is used to power the communication device. Thus, for example, if the communication device is a telephone, a user is able to press buttons on the telephone even though the telephone is not connected to the landline 104. This is desirable because during a cellular call, the telephone needs an external power supply. As noted above, line pair 104 provides such power during a landline call. Ringing SLIC 20 also performs on-hook and off-hook detection and generates on-hook and off-hook detection signals that are provided to DSP 22 in response to these detections. On-hook refers to the state in which the communication device is not being used such as when a telephone handset is placed on the cradle. Off-hook is the state when the communication device is in use such as when a telephone handset is removed from the cradle, releasing the hook switch. Ringing SLIC 20 performs serial communication by sending data over a bus 44 to DSP 22 using a standard communication protocol such as 4-wire Serial Peripheral Interface (SPI) protocol. Bus 44 is used to send status information (on-hook, off-hook, ringing, etc.) to DSP 22, and DSP 22 uses bus 44 to send commands and retrieve information from ringing SLIC 20.

DSP 22 is the central processor of interface circuitry 106 and controls all the functions thereof. For example, DSP 22 is connected via bus 48 to the external data connector of the cellular communication device 108. DSP 22 can control the functions of the cellular telephone (e.g., dialing, answering incoming calls, ending calls, power on/off, etc.) via commands sent over bus 48. Software is programmed into DSP 22 and/or is accessible from memory 42 to implement the various functions described herein. While a DSP is used as a control circuit in the example embodiment, it will be appreciated that various other types of control circuits including microprocessors, microcontrollers, logic circuits, application specific integrated circuits (ASICs), programmable array logic, etc. and combinations thereof may be used to implement some or all of the functions described herein.

DAA 36 is an analog interface to line pair 104 whose primary function is to monitor the voltage/current of line pair 104 and to detect incoming landline calls. DAA 36 is connected to DSP 22 via a bi-directional serial communication line 46 and communicates with DSP 22 when certain events occur such as an incoming landline call. DAA 36 detects incoming CID information, functions as a data modem, and may be provided with protocol stacks for applications such as Internet access (e.g., dial-up) and voice-over-IP (VoIP). The DAA has analog-to-digital converters for converting the analog audio signal from line pair 104 to a digital stream that is sent to DSP 22 and digital-to-analog converters for converting digital audio from DSP 22 to analog audio signals that are output to line pair 104. DAA 36 complies with the telephone standard of many countries. 2-to-4-wire (hybrid) converter 40 is a line interface provided between communication device 102 and cellular communication device 108 for, among other things, providing line impedance matching and 2-to-4 wire conversion. Converter 40 permits communication device 102 to send/receive audio to/from cellular communication device 108.

The example interface circuitry shown in FIG. 2A includes various switches to connect/disconnect elements from each other. DSP 22 controls these switches. For ease of illustration, the connections between DSP 22 and the switches are not shown in FIG. 2A. Although these switches are shown in FIG. 2A as hardware switches, the switching may in fact be implemented in software as discussed in detail below with reference to FIG. 2C. First switch 30 is used to disconnect communication device 102 from line pair 104 to reduce the possibility of the user hearing noise if the user is on a cellular call and there is an incoming landline call, or if someone is on another extension in the home or office. First switch 30 is used in conjunction with third switch 34 to allow calls to be placed from communication device 102 either via PSTN 105 or cellular communication network 107. Second switch 32 is used to selectively connect/disconnect DAA 36 to line pair 104. This arrangement allows DAA 36 to monitor all activity of line pair 104 (i.e., incoming calls, line voltages, etc.). Second switch 32 is used in conjunction with hold switch 12 to place a landline call on hold without disconnecting it. Third switch 34 is used to disconnect communication device 102 from ringing SLIC 20 during a landline call. This avoids damage to ringing SLIC 20 when the communication device 102 is being used in landline mode (e.g., placing or receiving a landline call). Hold switch 12 selectively connects a 350-ohm resister of hold circuit 11 across the line pair 104 and permits a call to be placed on hold without the call being disconnected by the local phone company. Finally, audio switch 38 switches the audio path between cellular communication device 108 and communication device 102 on and off. Audio switch 38 allows the system to place a cellular call on hold, while the user answers a landline call during a call-waiting situation. If desired, audio switch 38 may be omitted and a mute function of converter 40 may be used to perform functions similar to those of audio switch 38.

To make a call over PSTN 105, the user first places communication device 102 in the off-hook state. Ringing SLIC 20 detects this off-hook state and sends an off-hook signal to DSP 22. In response to the off-hook signal, DSP 22 closes second switch 32 and third switch 34, and opens first switch 30, audio switch 38 and hold switch 12. The user then presses the # button. Ringing SLIC 20 detects this button press and sends the # button press code to DSP 22. In response to the # button press code, DSP 22 connects communication device 102 to line pair 104 by controlling the various switches so that first and second switches 30, 32 are closed and third switch 34, hold switch 12 and audio switch 38 are open. The user then dials a telephone number to place a call over PSTN 105. If the called party answers, communication such as conversation may begin. If the called party does not answer, the calling party hangs up and communication device 102 is then in an on-hook state.

To make a call over cellular communication network 107 via cellular communication device 108, the user again places communication device 102 in the off-hook state. Ringing SLIC 20 detects this off-hook state and sends an off-hook signal to DSP 22. In response to the off-hook signal, DSP 22 closes second and third switches 32, 34 and opens first switch 30, audio switch 38 and hold switch 12. The user then dials the desired telephone number, which is detected and decoded by ringing SLIC 20 and forwarded to DSP 22. When the user presses “#” after entering the telephone number, DSP 22 closes audio switch 38 and then communicates the telephone number over bus 48 to cellular communication device 108, which thereafter dials the number. DSP 22 may, for example, use RS232 protocol at 9600 baud to communicate over bus 48 with the cellular telephone, although other protocols may readily be utilized. Because audio switch 38 is closed, an audio path is provided between cellular communication device 108 and communication device 102. If the called party answers, communication such as conversation may begin. If the called party does not answer, the calling party hangs up and communication device 102 is then in an on-hook state. Ringing SLIC 20 detects the on-hook state and sends an on-hook signal to DSP 22. DSP 22 thereafter ends the cellular call and disconnects communication device 102 from cellular communication device 108 by opening audio switch 38.

In the above-described implementation, the interface circuitry connects the communication device 102 for a PSTN call in response to the input of a predetermined code before the user enters a telephone number and connects the communication device for a wireless network call in response to the input of a predetermined code after the user enters a telephone number. Of course, it will be readily appreciated that the interface circuitry may be configured to connect the communication device for a wireless call in response to the input of a predetermined code before the user enters a telephone number and to connect the communication device for a PSTN call in response to the input of a predetermined code after the user enters a telephone number.

FIG. 2B is a detailed schematic showing the interconnections of the various switches in the example interface circuitry 106 shown in FIG. 2A. As discussed above, DSP 22 controls the switches in order to perform various functions and operations. A first switch configuration is used when placing or receiving a call via PSTN 105. In this configuration, first and second switches 30A, 30B, 32A, 32B are closed and third switch 34A, 34B; hold switch 12A, 12B; and audio switch 38A, 38B are open. In this first switch configuration, communication device 102 is connected via closed first and second switches 30, 32 to line pair 104. Audio switch 38 is open to disconnect communication device 102 from the cellular communication device 108. Because communication device 102 receives power from line pair 104, third switch 34 is also open. A second switch configuration is used when placing or receiving a call via cellular communication network 107. In this second configuration, first switch 30A, 30B and hold switch 12A, 12B are open. Second and third switches 32A, 32B, 34A, 34B and the audio switch 38A, 38B are closed. Closing switch 32A, 32B allows DAA 36 to detect incoming calls via PSTN 105 when the communication device 102 is being used for a cellular call. A third switch configuration is for the on-hook state (i.e., when communication device 102 is not being used to place or receive a landline or a cellular call). In this third configuration, first switch 30A, 30B; hold switch 12A, 12B; and audio switch 38A, 38B are open. Second and third switches 32A, 32B, 34A, 34B are closed.

To place a landline call on hold and connect to a cellular call, switch 12A, 12B is closed and the second switch configuration is then utilized. To place a cellular call on hold and connect to an incoming landline call, the first switch configuration is utilized. Thus, the user has call waiting between landline and cellular calls and the user can press the flash button on their phone to activate this feature (i.e., place the landline call on hold, and answer incoming cellular call or vice versa) when they hear the special call waiting tone. If the user does not subscribe to call waiting, there is a possibility that during a call waiting event (e.g., the user is on a landline call, and there is an incoming cellular call), when the user presses the flash button, the local telephone company will see this flash event and disconnect the landline call. This is because when the flash button is pressed the telephone goes in the on-hook state for 300-700 ms and then goes back into the off-hook state. In short, if the user does not subscribe to a call waiting service, the phone company may disconnect the landline call when the flash button is pressed. To circumvent this problem, the flash button is re-mapped to another button on the telephone such as the “*” button. In this case, during a call waiting event (as described above) the user presses the “*” button instead of the flash button on his/her telephone. The telephone company will know that the “*” button is pressed, but this press will be ignored. On the other hand, because the interface circuitry can detect an incoming call, when it detects that the “*” button is pressed during a call waiting event, the system places the landline call on hold, and connects the user to the cellular call. This flash functionality can also be provided using a dedicated flash button. Call conferencing between cellular and landline calls may be accomplished in response to an appropriate user input by closing audio switch 38 and placing the other switches in the same configuration as for a landline call (i.e., the first switch configuration described above).

FIG. 3 is a table summarizing the states of the switches in the example interface circuitry 106 shown in FIG. 2A for various representative functions and operations.

FIG. 2C is a circuit block diagram of another example of interface circuitry 106. In this example, interface circuitry 106 does not use hardware switches and the switching is done in software by compressed digital audio as opposed to the raw analog audio signal. The functionality of the FIG. 2C interface circuitry is the same as that of the FIG. 2A interface circuitry; however, the FIG. 2C interface circuitry provides more robustness. For example, the FIG. 2C interface circuitry converts all audio to a digital format, which allows the audio signals to be enhanced using conventional digital signal processing techniques. For example, if the audio to/from line pair 104, communication device 102, and/or the cellular phone 108 is unclear or noisy, DSP 122 can remove this unwanted noise from the audio signal. The audio from line pair 104 can be digitized by DAA 136, and the audio from communication device 102 and cellular telephone 108 can be digitized by ringing SLIC 120. In the following description, communication device 102 is assumed to be a telephone, although, as noted above, the invention is not limited in this respect.

The user makes a landline call as follows. First, the user picks up the telephone (i.e., places the telephone in an off-hook state) and enters a predetermined code for a landline call. The user then dials the telephone number of the called party. Ringing SLIC 120 detects the numbers being dialed and sends this information to DSP 122. DSP 122 instructs DAA 136 to go off hook, and DAA 136 dials the telephone number of the called party. If the called party answers, DAA 136 captures, digitizes and compresses the audio from the called party that is communicated over landline 104. This compressed digital data is communicated to DSP 122. DSP 122 can optionally process the compressed digital data using digital audio techniques such as audio quality enhancement. DSP 122 sends the digital audio to ringing SLIC 120 via a digital audio data bus 45 (e.g., a PCM serial bus). Although busses 44 and 45 are shown separately, they may be provided as a single bus in another implementation. Ringing SLIC 120 decompresses the audio and converts the digital signal back into analog audio signals, which are then supplied to the telephone so that the user can hear them.

Analog audio from the calling party is supplied to ringing SLIC 120, which digitizes and compresses the audio and communicates the digital audio signal to DSP 122 over the digital audio path. DSP 122 can optionally utilize digital audio processing techniques on the digital audio to, for example, provide audio enhancement. The digital audio signal output from DSP 122 is supplied to DAA 136, which decompresses the audio and converts the digital signal to an analog signal that is then transmitted to the called party via line pair 104.

To make a cellular call from the telephone, the user follows the steps discussed above with respect to the interface circuitry of FIG. 2A. Call conferencing between cellular and landline calls may be accomplished by connecting both DAA 136 and cellular phone 108 to ringing SLIC 120 simultaneously.

Additional details of the operation, features and uses of the interface circuits of FIGS. 2A-2C can be found in application Ser. No. 10/615,408, the contents of which are incorporated herein in their entirety.

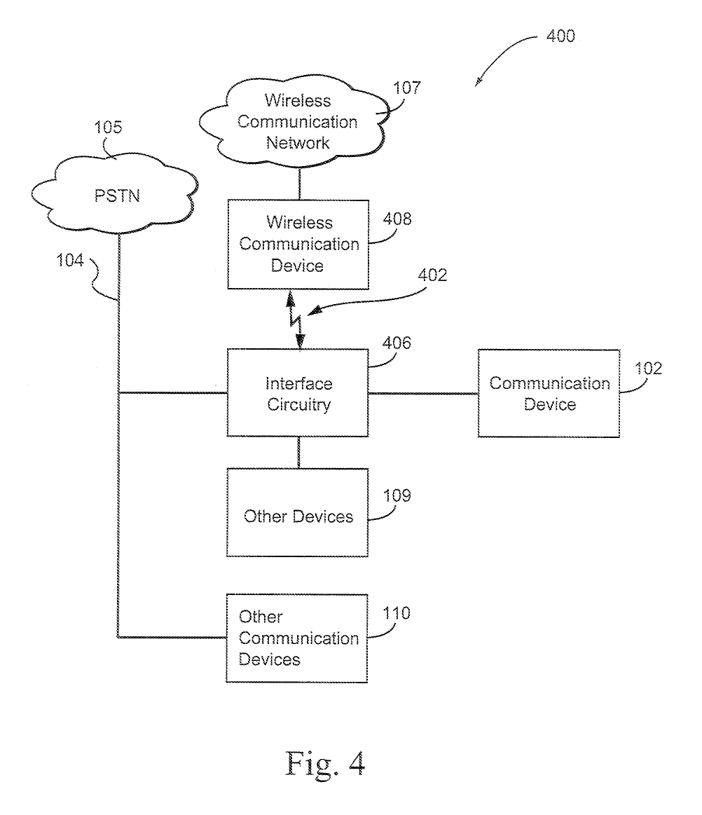

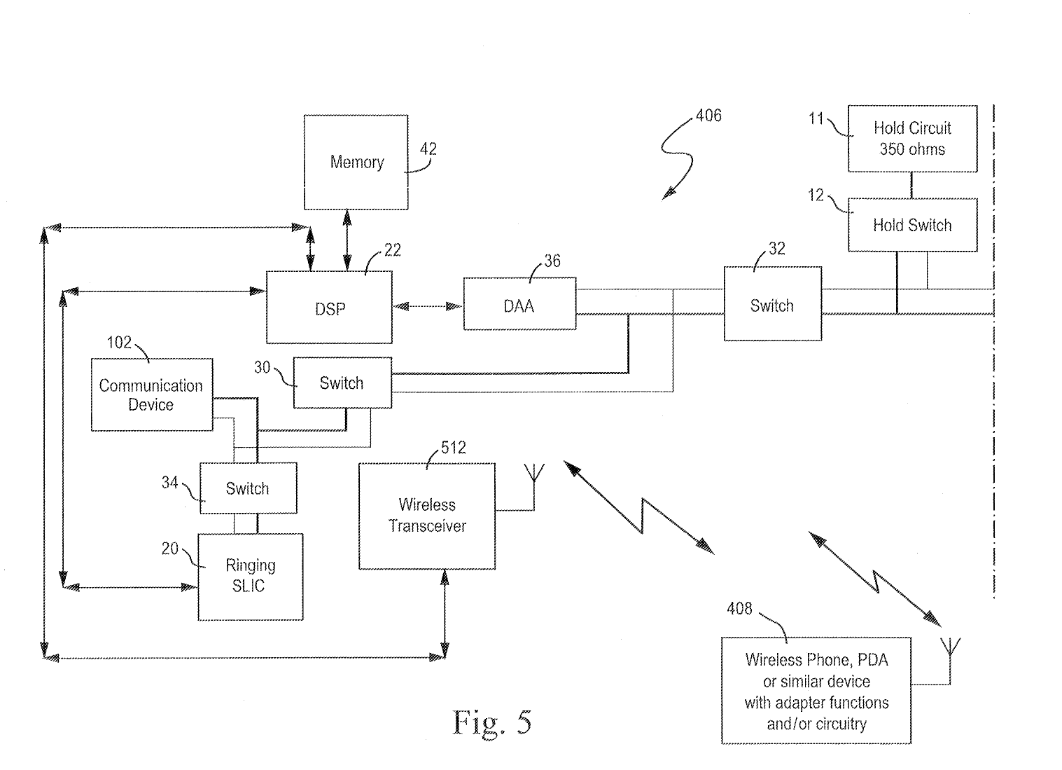

FIG. 4 is a generalized block diagram of another example communication system 400. The portions of communication system 400 that are the same as communication system 100 are designated with the same reference numeral and a description thereof is omitted. Communication system 400 includes interface circuitry 406 that includes a wireless interface to a wireless communication device 408. More specifically, communication system 400 allows communication device 102 (such as a landline home telephone) to place and receive calls and/or to access data via a wireless link 402 to a wireless communication device 408 such as a cellular telephone or a personal digital assistant (PDA). The wireless link 402 may use any wireless protocol including, but not limited to, Bluetooth protocol; any type of 802.11 (Wi-Fi) protocol; HiperLAN/1 protocol; HiperLAN/2 protocol; HomeRF protocol; cordless telephone protocols; Ultra Wide Band (UWB); WiMax; and other similar wireless protocols. Such a wireless link to wireless communication devices such as a cellular telephone, personal digital assistant and the like provides for an even more user-friendly system and an even more robust product. Among other things, there is no need to physically place the wireless communication device 408 in a cradle having direct physical connections to interface circuitry 406. As long as wireless communication device 408 is located within the communication range of the wireless protocol, interface circuitry 406 can access the wireless communication device 408 to, among other things, place and receive calls, access data available on cellular networks, or access data that is contained within the wireless communication device itself such as telephone numbers, calendars, e-mails, and the like.

Generally speaking, wireless link 402 between wireless communication device 408 and interface circuitry 406 is a short-distance (e.g., less than about 150 meters) link. For example, the range for Bluetooth communications is generally about 10 meters, with some higher-power systems having a range of up to about 100 meters. The range for UWB communications is generally about 10 meters. Of course, it will be readily recognized that wireless link 402 between wireless communication device 408 and interface circuitry 406 is not limited to such short distance links.

FIG. 5 is a circuit block diagram of one example of interface circuitry for use in the system of FIG. 4. FIG. 5 shows interface circuitry 406 that is configured for wireless communication with wireless communication device 408. Wireless communication device 408 includes a wireless device such as a cellular telephone or PDA and adapter circuitry and/or functionality to be described in greater detail below. The portions of FIG. 5 that correspond to the interface circuitry shown in FIG. 2A have been identified with the same reference numerals and a detailed description of the operation thereof is omitted below.

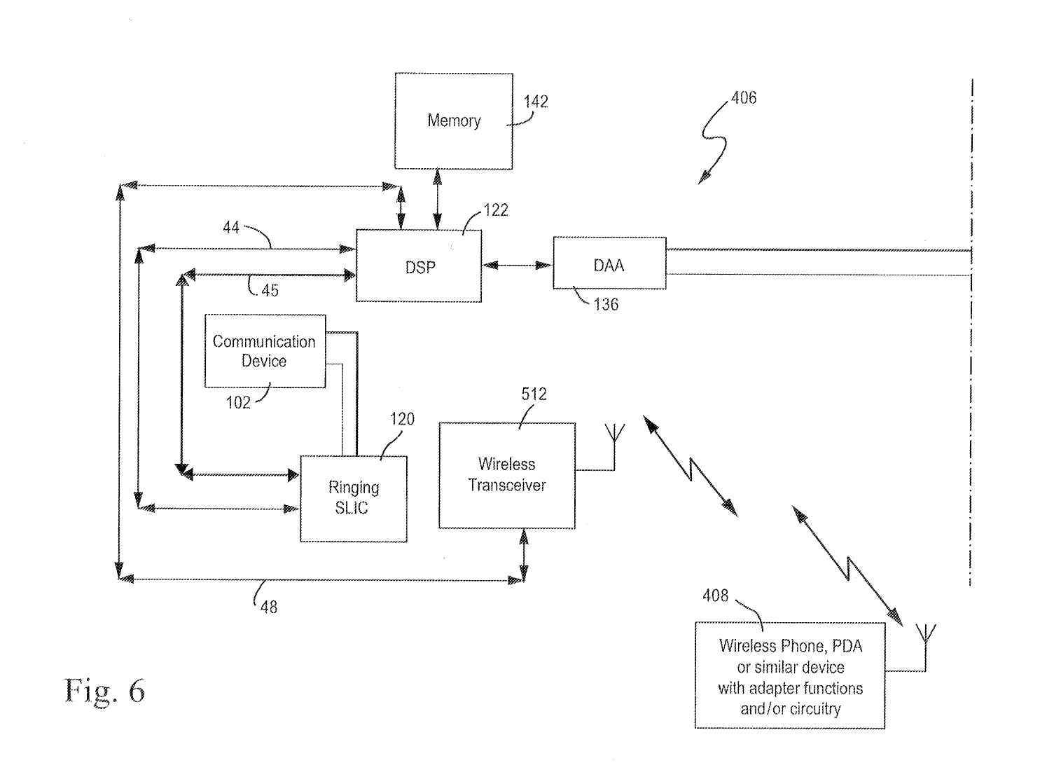

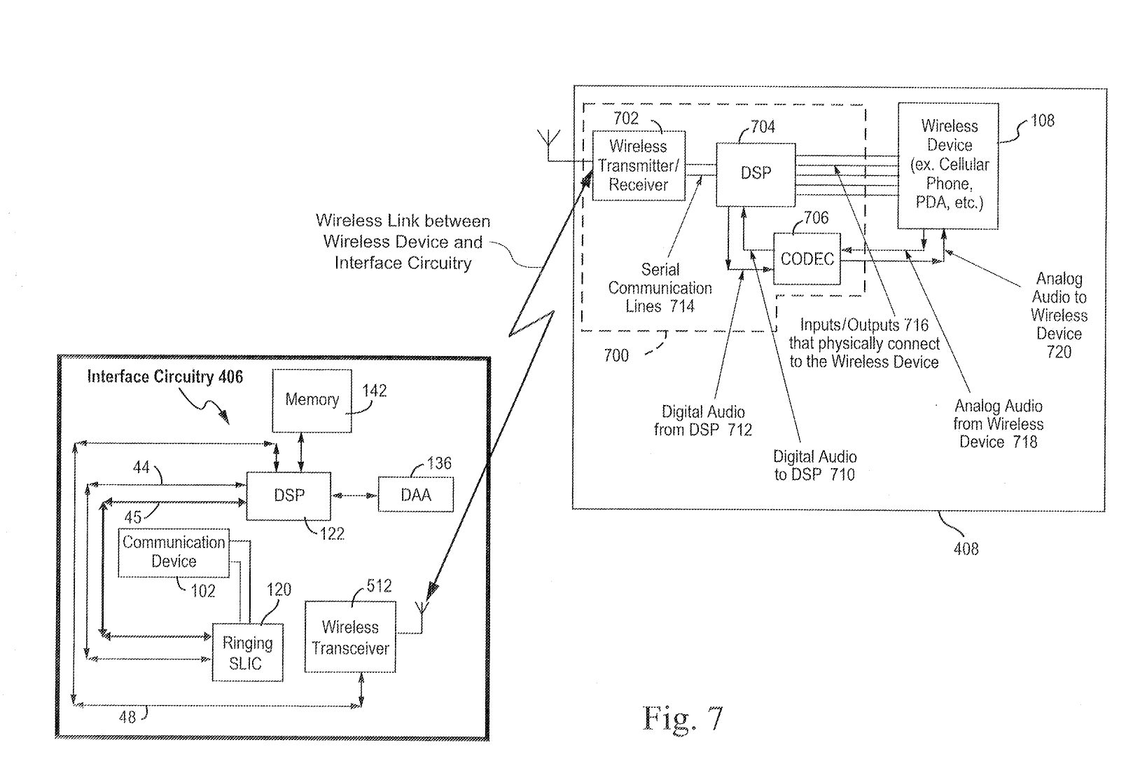

FIG. 6 is a circuit block diagram of another example of interface circuitry for use in the system of FIG. 4. Here again, wireless communication device 408 includes a wireless device such as a cellular telephone or PDA and adapter circuitry and/or functionality to be described in greater detail below. The portions of FIG. 6 that correspond to the interface circuitry shown in FIG. 2C have been identified with the same reference numerals and a detailed description of the operation thereof is omitted below.

As will be described in greater detail below, wireless communication device 408 either incorporates adapter functionality, or incorporates or is removably attachable to adapter circuitry that enables communication with wireless transceiver 512. For example, the adapter circuitry may be circuitry configured to be removably attached to the input/output pins of the wireless device.

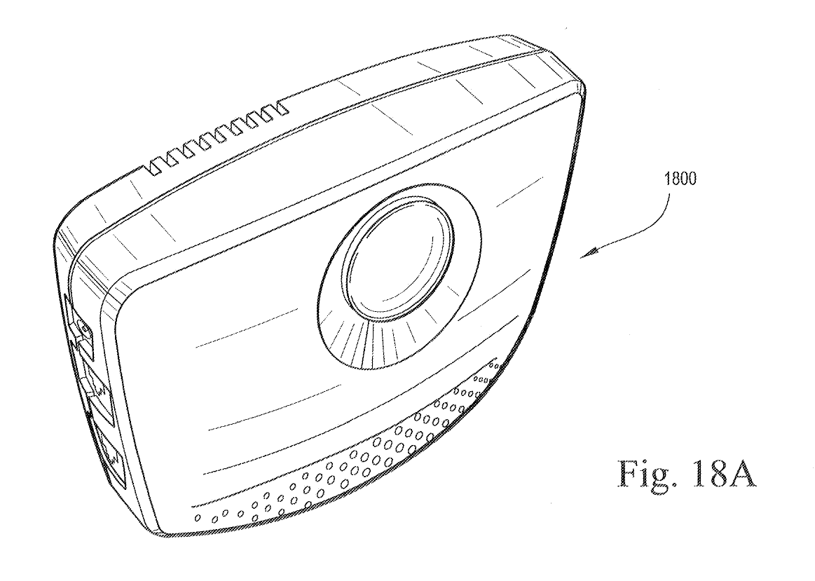

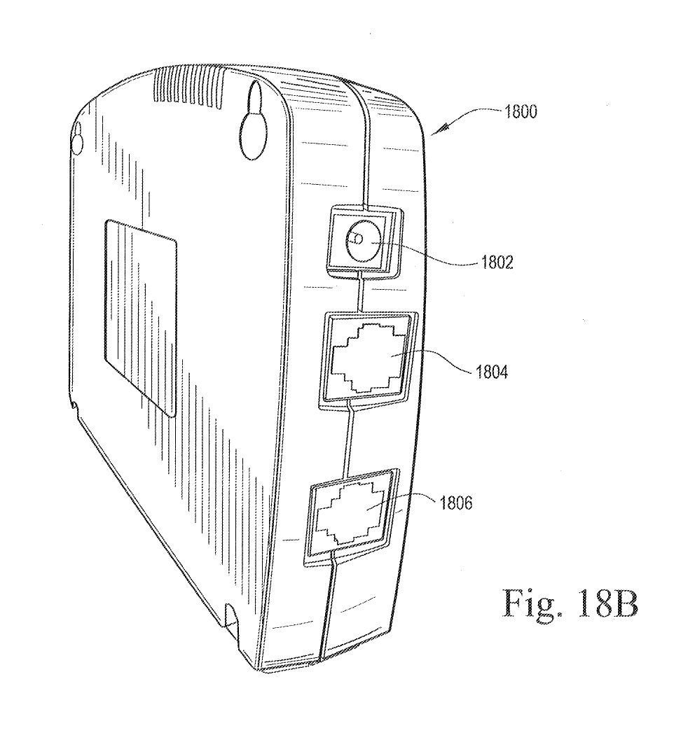

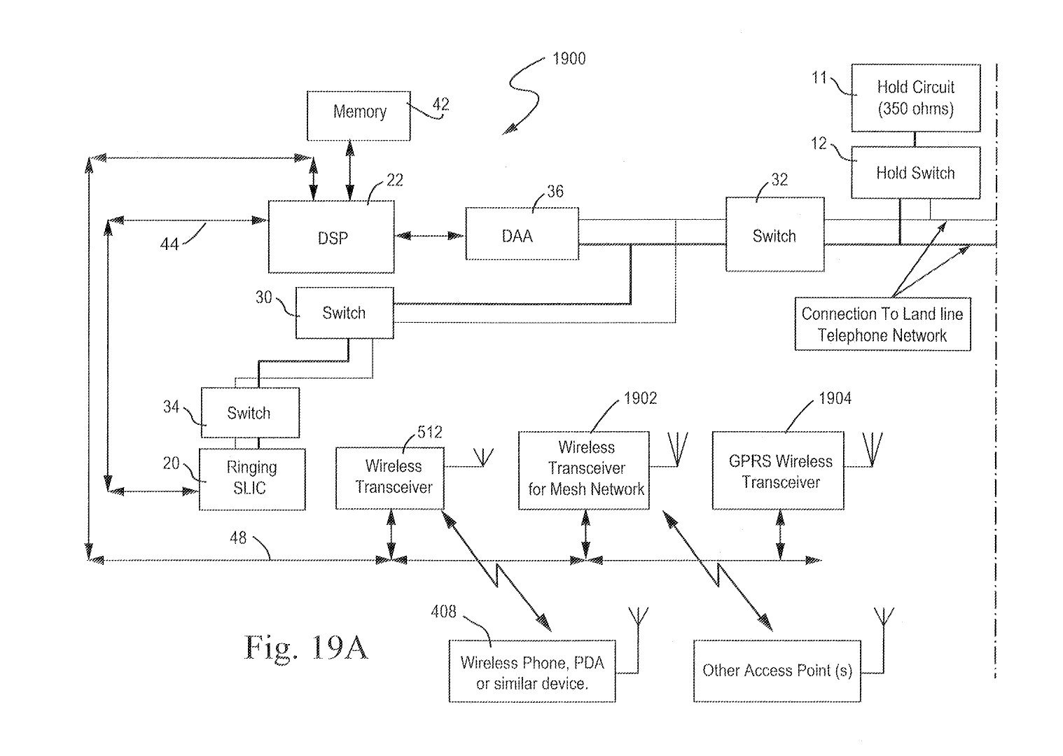

FIGS. 18A and 18B show interface circuitry 406 of FIG. 5 or FIG. 6 incorporated into a housing. Specifically, the interface circuitry 406 is incorporated into a housing 1800. By way of example, housing 1800 is made of a plastic material, but other materials such as metal may be used. The interface circuitry includes a connector 1802 for connecting to a power converter for converting the power from a wall outlet to a level and type suitable for powering the components of the interface circuitry. Connector 1804 is provided for a wired connection to communication device 102 and connector 1806 is provided for a wired connection to a landline line pair or to a VoIP gateway such as the Sipura SPA 1001 or another similar device.

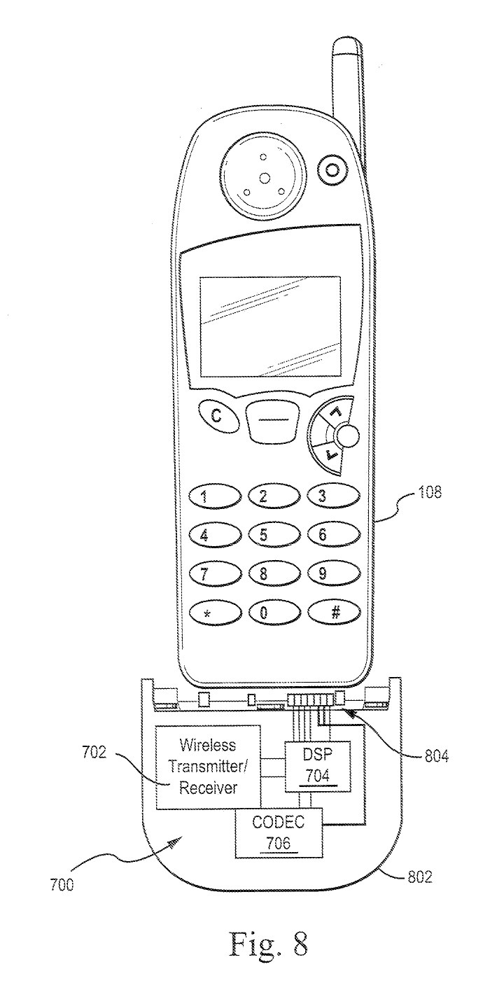

For purposes of discussion below, wireless communication device is assumed to be a cellular telephone. However, as noted above, the wireless communication device is not limited to a cellular telephone and may be another type of wireless device such as a PDA or an integrated cellular telephone/PDA. The following description with reference to FIGS. 7 and 8 involves example adapter circuitry 700 that is removably connectable to the input/output pins of a cellular telephone 108. This description is by way illustration, not limitation, inasmuch as it will be readily recognized that the functions of the adapter circuitry (or the circuitry itself) may be built into the cellular telephone.

With reference to FIG. 7, adapter circuitry 700 includes a wireless transmitter/receiver circuit 702 for wireless communication with wireless transceiver 512 of interface circuitry 406; a digital signal processor (DSP) 704; and a codec 706. Wireless transmitter/receiver circuit 702 is connected to DSP 704 by a link 714 such as serial communication lines. DSP 704 is connected to cellular telephone 108 via a link 716. DSP 704 is connected to codec 706 via a digital audio link 710, 712 and codec 706 is connected to cellular telephone 108 via analog audio link 718, 720.

FIG. 8 shows the components of adapter circuitry 700 incorporated in a housing 802 which is removably attachable to the input/output pins (or connectors) of cellular telephone 108. As shown in FIG. 8, adapter circuitry 700 includes connectors 804 for the data and audio links thereof that connect to the input/output pins of cellular telephone 108. Of course, the nature of these connectors of the adapter circuitry will depend on the type and/or model of cellular telephone 108. The cellular telephone with the attached adapter circuitry establishes a wireless link to interface circuitry 406 over which data (e.g., audio, video, text, etc.) can be transmitted and received.

Adapter circuitry 700 works as follows:
1. Wireless transmitter/receiver 702 wirelessly transmits data to and receives data from wireless transceiver 512 of interface circuitry 406;
2. The data received from interface circuitry 406 is transmitted to DSP 704 via link 714; and
3. DSP 704 processes the data received from wireless transmitter/receiver 702, and communicates the processed data to cellular telephone 108 using the physical link 716 to the input/output pins of cellular telephone 108.

Codec 706 is connected to the analog audio pins of the cellular telephone 108. Codec 706 receives analog audio from the cellular telephone, digitizes the audio and communicates the digitized audio to DSP 704. DSP 704 may optionally perform signal processing on the digitized audio from codec 706. DSP 704 is connected to a digital audio interface of the wireless transmitter/receiver 702. An example of this digital audio interface is a Pulse Code Modulation (PCM) bus, but other digital audio interfaces can also be used.

When audio data is sent between the two wireless transceivers, DSP 122 of interface circuitry 406 sends an instruction to the interface circuitry's wireless transceiver 512 to cause the transceiver to enter a digital audio mode. Upon receiving this command, transceiver 512 attempts to establish an audio communication link with adapter circuitry 700. A dedicated audio link is then established between interface circuitry 406 and adapter circuitry 700.

Audio is communicated from communication device 102 (such as a home telephone) to cellular telephone 108 as follows.

### Assumptions

An audio communication link is established between interface circuitry 406 and adapter circuitry 700.

### Audio Communication

1. Communication device 102 is connected to ringing SLIC 20 (120). The ringing SLIC digitizes analog audio from communication device 102 and sends the digital audio to DSP 22 (122) via a PCM bus or similar audio communication bus.
2. DSP 22 (122) receives the digital audio samples from the communication device.
3. DSP 22 (122) is also connected to the PCM bus of the wireless transceiver 512 and sends the digital audio to wireless transceiver 512 via this bus.
4. Wireless transceiver 512 automatically communicates the audio received on the PCM bus to wireless transmitter/receiver 702 in adapter circuitry 700.
5. Wireless transmitter/receiver 702 receives the digital audio samples and sends the digital audio to its PCM bus, which is connected to DSP 704.
6. DSP 704 optionally performs signal processing on the audio.
7. DSP 704 then sends this audio to codec 706.
8. Codec 706 converts this digital audio to analog audio that is supplied to the analog audio input pin of cellular telephone 108.

As noted above, FIG. 8 shows example adapter circuitry 700 that is removably attachable to cellular telephone 108. Of course, the adapter circuitry is not limited to being incorporated into such an attachment and could, for example, be incorporated into a desktop charger so that while cellular telephone 108 is placed in the cradle of the charger for charging, it will be connected to the adapter circuitry. In addition, as noted above, the functionality of the adapter circuitry may be incorporated within the wireless device. Still further, the adapter circuitry may be provided in the form of a “universal” adapter which includes a first portion with a fixed base and interchangeable second portions that connect to the fixed base and to different devices such cellular telephones or personal digital assistants or to different models of these devices.

Although not shown in FIGS. 7 and 8, adapter circuitry 700 may include its own battery for powering the components thereof and/or supplementing the battery of the cellular telephone to which it is connected. If a battery is provided, adapter circuitry 700 may also include a battery indicator light(s) for indicating the state of the battery (e.g., green if the battery is okay, red if the battery needs to be changed). Alternatively, adapter circuitry 700 may be powered by the battery of the cellular telephone or, if the adapter circuitry is incorporated into a desktop charger, from the charger. The adapter may also include its own user interface including input devices (e.g., keys, buttons switches, etc.) and output devices (e.g., speaker, display such as a liquid crystal display, etc.). Still further, adapter circuitry 700 may include memory for storing various data including telephone numbers and program instructions.

The interface circuitry may optionally include signal-boosting circuitry to boost the cellular signals to and from cellular telephone 108 because cellular signals are often weak in home, office and campus environments. Physically connecting the cellular telephone 108 to the interface circuitry allows the cellular telephone to be connected to boosting circuitry contained in the interface circuitry. However, boosting circuitry in the interface circuitry would not be useful if the interface circuitry is not physically connected to cellular telephone 108. In this situation, the cellular communication circuitry of cellular telephone 108 could suffer a problem of not being able to communicate to the wireless network. Accordingly, adapter circuitry 700 may also include signal-boosting circuitry for boosting signals to cellular telephone 108. This circuitry may be connected to the cellular telephone via the cellular telephone's external antenna connector (not shown).

To enable effective communication between interface circuitry 406 and adapter circuitry 700, the adapter circuitry may be “registered” to the interface circuitry so that communication device 102 (e.g., the home telephone) will be able to place/receive cellular calls, and transmit/receive data to/from the wireless network using any wireless device that is connected to the adapter circuitry. Some wireless protocols provide for such registration. For example, the Bluetooth protocol provides for “pairing” or “bonding” that allows two Bluetooth-enabled devices to exchange information about themselves such as their limitations, the services they support, RF communication ports, link keys, etc. Once the process is completed, the “paired” devices can then exchange data.

In addition or alternatively, a registration process such as the following can be used. Specifically, adapter circuitry 700 may be registered to interface circuitry 406 by the user entering a 4-digit number (or some other type of identifier) into the communication device 102. Once this number is received, interface circuitry 406 appends to this number a random number (e.g., a 32-bit random number), stores the resulting number in its non-volatile memory (e.g., memory 42 (142)) and transmits this number wirelessly to adapter circuitry 700 which will then program this number into a non-volatile memory thereof. Communication between interface circuitry 406 and adapter circuitry 700 registered thereto may use this number. The illustrative step-by-step adapter circuitry registration to interface circuitry 406 is as follows:

### Assumptions

1. interface circuitry 406 and adapter circuitry 700 are connected to respective power supplies;
2. adapter circuitry 700 is within the communications range of interface circuitry 406; and
3. the user has a communication device (e.g., home telephone—corded or cordless) connected to interface circuitry 406.

### Adapter Circuitry Registration Process

1. the user presses *R (R: Registration) on communication device 102 that is connected to the interface circuitry 406
   a. interface circuitry 406 enters an adapter circuitry registration mode
   b. user enters his/her name into communication device 102 using, for example, an associated key pad
      i. interface circuitry 406 sounds a tone to indicate name was received
   c. interface circuitry 406 sounds a tone to prompt user to enter a PIN number (e.g., a 4-digit pin number)
2. the user enters the pin number
   a. interface circuitry 406 receives the pin number and appends (or prepends) it to a random number (e.g., a 32-bit random number)
   b. interface circuitry 406 stores this number in its internal non-volatile memory as an identification number and communicates this identification number to adapter circuitry 700.
      i. adapter circuitry 700 sends an acknowledge signal to interface circuitry 406
   c. adapter circuitry 700 stores the identification number in its non-volatile memory
   d. adapter circuitry 700 sends an acknowledge signal to interface circuitry 406 to indicate that storing of the identification number was successful
3. interface circuitry 406 sounds a tone upon receiving a successful message from the adapter circuitry

The above process can be repeated to register numerous adapter circuits to interface circuitry 406. Each adapter circuit will have its own identification number and a name associated to it. Once the adapter circuitry has been registered to interface circuitry 406, communication device 102 can access the wireless device that is connected to the adapter circuitry to, among other things, place and receive cellular calls or send and receive data using the wireless networks.

Because numerous adapter circuits can be registered to interface circuitry 406 and can be within the range of the wireless communication protocol, a method may be provided to determine which wireless device the interface circuitry will access. For example, a household may have two or more cellular telephones and both of these telephones may have their own adapter circuitry that can be registered to interface circuitry 406 when it is within the range of the communication protocol. This situation can cause problems because interface circuitry 406 would not know which cellular telephone to use to place cellular calls. One example solution to this problem is the following.

When a user of interface circuitry 406 wants to place a call on a cellular phone, the user is prompted with the following question (which is displayed on caller ID screen of the home telephone).

### Which Phone?

1. Mary
2. John
   At this point, the user can press “2” on his/her home telephone if he/she wants to place a cellular call users John's cellular phone. The display of names is generated based on the names in memory 42 (142) of interface circuitry 406 that have been entered during the registration processes. Once a name is selected, the corresponding programmed number (i.e., random number plus PIN) is retrieved from memory 42 (142) and used for communication with the appropriate adapter circuitry.

Alternatively, during an incoming call, interface circuitry 406 will display on the home telephone caller ID screen, which cellular phone is ringing, and the caller who is calling. For example, the home telephone may display the following.

Mary (this means there is an incoming cellular call to Mary's phone)
Sara Smith (this means Sara Smith is calling Mary's cellular phone)
123-555-1234 (this is the phone number of Sara Smith)

The above processes assume that Mary's cellular telephone is connected to adapter circuitry that has been registered as “Mary's” and that John's cellular telephone is connected to adapter circuitry that has been registered as “John's.” If desired, another registration process could be provided for registering cellular telephones to adapter circuitry. In this way, it would be possible to select Mary's or John's cellular telephone (or determine whether John's or Mary's cellular telephone was ringing) regardless of which adapter circuitry these cellular telephones incorporate or are attached to.

Adapter circuitry may also be configured to allow home telephones to place and receive VoIP telephone calls via an Internet-connected home computer. Currently, computer users may place VoIP telephone calls via their home computer. Although these calls are at no or little cost, the VoIP users generally must sit in front of their computer for the duration of the VoIP telephone call. Adapter circuitry can be connected to the external audio connections of the computer (e.g., audio out/speaker, audio in/microphone) to allow the user to use his/her home telephone (corded or cordless) that is connected to the interface circuitry to talk with a called party without having to be physically sitting in front of the computer.

In addition to connecting to the audio out/audio in connections of a computer, adapter circuitry can be connected to the USB port of the computer. This connection allows the user to receive/transmit information from/to his/her personal computer. In addition, the USB connection allows the interface circuitry to have the capability to place and receive landline, cellular, and VoIP telephone calls.

With respect to VoIP telephone calls, a computer program running on the user's computer receives a data request from the adapter circuitry. The following is a step-by-step description of how a VoIP telephone call can be placed from communication device 102 that is connected to interface circuitry 406.

### Assumptions

1. user has a computer that is in an active internet connection;
2. user has communication device 102 connected to interface circuitry 406;
3. user has adapter circuitry connected to the USB port and to audio input/output jack(s) of his/her computer;
4. user has a software application running on his/her computer which will accept commands from the adapter circuitry; and
5. user has configured the software application from assumption 4 to go to a certain website (e.g., Dialpad, net2phone, etc.) to place a VoIP call.

### VoIP Call

1. user takes communication device 102 off-hook
   a. user hears a dial tone
   b. interface circuitry 406 prompts user with the following menu
      1. Landline
      2. Cellular
      3. VoIP
2. user presses 3 to place a VoIP call
   a. interface circuitry 406 sounds a tone that indicates it is ready for telephone number to be entered
3. user enters number he/she wishes to call
4. interface circuitry 406 wirelessly communicates the telephone number to the adapter circuitry that is connected to the computer
5. the software application receives the number and navigates to the previously chosen website and submits the number for calling

The call is then established and audio is sent to/from the computer to the telephone that is connected to interface circuitry 406 via the adapter circuitry that is connected to the computer. The adapter circuitry connected to the computer may be registered to the interface circuitry as described above.

The functions of adapter circuitry 700 may be implemented using many different arrangements of hardware, firmware and/or software and the invention is not limited to the specific implementation shown in FIGS. 7 and 8.

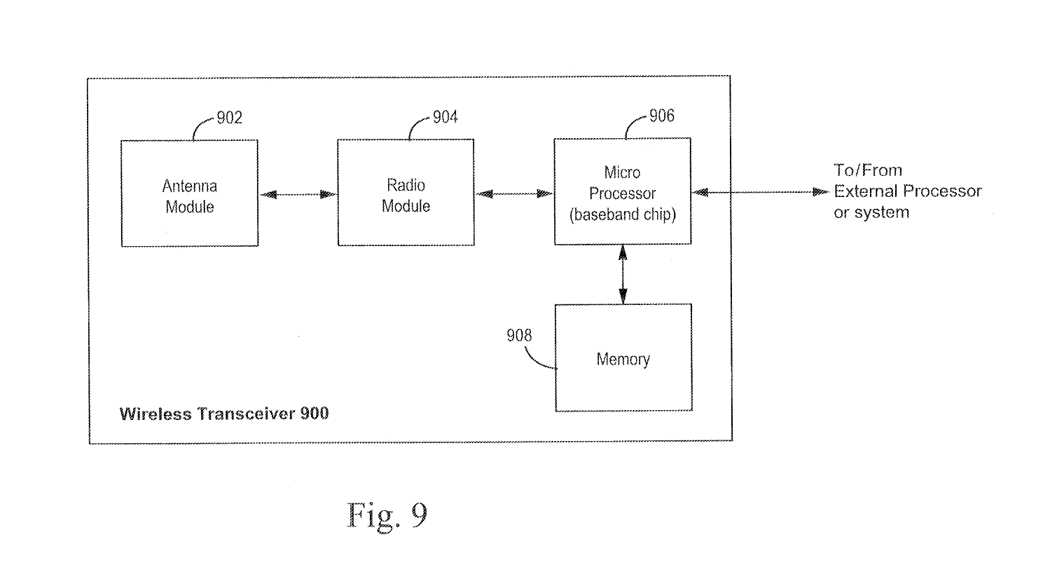

For example, the functions may be incorporated into an example wireless transceiver module 900 like that shown in FIG. 9. Wireless transceiver module 900 includes an antenna module 902, a radio module 904, a microprocessor 906 and a memory 908. Microprocessor 906 performs digital signal processing to process the protocol stack of the wireless protocol that is used to send data to and receive data from radio module 904. Microprocessor 906 may include in its architecture serial communication buses, a codec, general-purpose input/output pins, a debugging interface, and an external memory interface. The serial communication buses may include a universal serial bus (USB) allowing high-speed serial communication between microprocessor 906 and an external host processor and/or system. A universal asynchronous receiver-transmitter (UART) bus may be provided to allow serial communication between microprocessor 906 and the external host processor and/or system. The codec provides for transmitting digital audio to and receiving digital audio from the external host processor and/or system. An example of a host processor and/or system is the processing system of a wireless device such as a cellular telephone or a PDA. Other examples of an external host processor and/or system include a personal computer that may be used, for example, in connection with the VoIP implementation described above. Still other examples include a wireless headset. Of course, while a microprocessor is shown in FIG. 9, other processing circuits such as application specific integrated circuits (ASICs), digital signal processors (DSP), programmable logic arrays (PLAs) and the like may be used in conjunction with or in place of the microprocessor. In addition, it is possible to incorporate the functions of microprocessor 906 and the functions of the external microprocessor into a single microprocessor.

Radio module 904 is a transceiver that transmits the data it receives from microprocessor 906 using a frequency hopping modulation technique. An example of such a technique is GFSK (Gaussian Frequency Shift Keying). The transmitting section of radio module 904 may be connected to an amplifier which is in turn connected to antenna module 902. Radio module 904 also receives and decodes data that is then supplied to microprocessor 906. Memory 908 stores the protocol stack software and other software modules or data needed by microprocessor 906.

A similar transceiver module may be used to implement wireless transceiver 512. Of course, other designs may be used and the invention is not limited in this respect.

Using the same procedure as that for making a VoIP telephone call, a user may send and receive instant messages (IM) to/from his/her home telephone to another party. Computer users may communicate to other IM users using text messages. In addition, many popular IM services such as Yahoo and AOL also permit instant voice messaging or voice chat. A user can switch between voice and text messaging at any point during an IM session. For example, IM software often includes a button or icon that allows a user to enable voice messaging. When this button is pressed, the IM software sends a message to the other party that requests permission to go into voice messaging mode. If the other party accepts, then half-duplex voice conversation is initiated between the two parties.

To implement text/voice messaging in the context of the systems described herein, a software “plug-in” or “add-on” is provided for the instant messaging client that runs locally on the user's personal computer or similar device. The user turns on a switch within the software to allow instant messages to be sent to his/her home telephone in the event the user is away from the personal computer. An example implementation follows.

### Assumptions

1. IM client is running on the user's personal computer or similar device.
2. The user is logged onto an IM server (e.g., Yahoo, AOL, MSN, etc.)
3. The user has installed a plug-in or add-on for the IM client.
4. The user has turned on an option for phone chat.

If someone sends the user a instant message, the plug-in or add-on detects this incoming message and sends a message to interface circuitry 406 to ring home telephone 102. The interface circuitry distinctively rings the home telephone to provide an indication to the user that an instant message has been received. When the telephone is answered, a voice prompt announces the following: “Incoming instant message. Press 1 to accept; Press 2 to decline.” If the user presses “2” on the keypad of the telephone, then a “decline” message is sent to the plug-in or add-on via the adapter circuitry attached to the personal computer. When the decline message is received by the plug-in or add-on software, a message such as “The party is not available” is sent to the user who sent the original message.

If the user presses the “1” on the keypad of the telephone to accept the incoming instant message, a message is sent to the software on the personal computer via the adapter circuitry. This message causes the software to send a request to enable voice messaging to the user that sent the original instant message. If the original sending party accepts the request for voice messaging, then a half duplex voice conversation may begin.

Using this scheme is also possible to do text based instant messaging using the keypad of the telephone. Text-to-voice and voice-to-text technologies may be used to enable one party to use voice messaging and the other party to use text-based messaging.

The systems described herein have many features and applications that require the user to use various key press combinations to enable certain features. To provide a more user-friendly interface, an intelligent voice-driven system may be used. With such a system, the user need only remember one (or a small number) of key-press combinations (e.g., “* #”) to activate the voice-driven system. An example of the voice-driven system follows.
1. When the user takes the telephone off-hook, he/she hears the following voice prompt: “Press 1 to make a landline call, Press 2 to make a cellular call”
   a. If the user presses 1, the user is connected to the landline
   b. If the user presses 2, the user hears the following prompt “Enter the number you wish to dial, then press # to send”
2. The voice system keeps track of the current user and/or overall system state and preferably only prompts the user with appropriate voice messages. An example follows.
   a. The user is on a landline call and, during this call, an incoming cellular call is detected.
      i. At this point, the user is prompted with the following message “Incoming Cellular call, Press flash to connect”
         1. If “flash” is pressed, the system places the landline call on hold and connects the user to the cellular call.
      ii. If the user wants to initiate a conference call between the landline and cellular telephone, the user may press * # to activate the voice-driven system. Because the system “knows” the current state of the calls, the user is automatically prompted with the following message: “Press *2 to conference both calls.”

An example system and method in which a standard home telephone with one base station is used with numerous satellite cordless handsets to, for example, place and receive multiple cellular calls on a number of cellular phones simultaneously will now be described.

It is now commonplace to find expandable home telephone systems including a base station and up to seven (7) cordless satellite handsets. These additional handsets need not be plugged into the RJ11 telephone wall jack. All audio signals are transferred to the cordless satellite handsets via the base station. The Siemens Gigaset and Uniden 2.4 GHz expandable cordless phone are examples of such telephone systems.

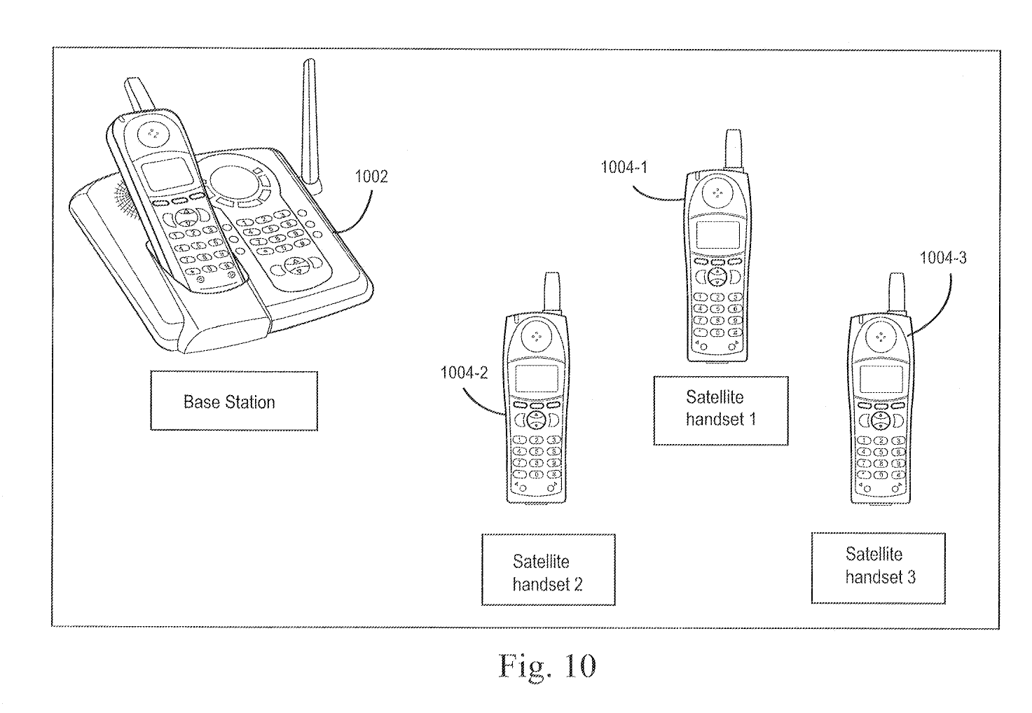

FIG. 10 is an example of a system in which multiple cordless satellite handsets are associated with a single base station. Base station 1002 is connected to one or more RJ11 telephone wall jacks for the landline telephone system. Each of the cordless satellite handsets 1004-1, 1004-2 and 1004-3 is registered to base station 1002, and thus can place and receive landline calls via base station 1002. For example, if handset 1004-1 is taken off-hook, a signal is sent to base station 1002, and then base station 1002 also goes off-hook. Base station 1002 relays all audio signals to and from the handset and thus allows the user to place and receive landline telephone calls.

By incorporating various features described above (e.g., those described in connection with FIGS. 4-9) into the base station of a telephone system like that of FIG. 10, the cordless handsets can be used to place and receive wireless calls (e.g., over a cellular network) using various wireless phones separately or simultaneously.

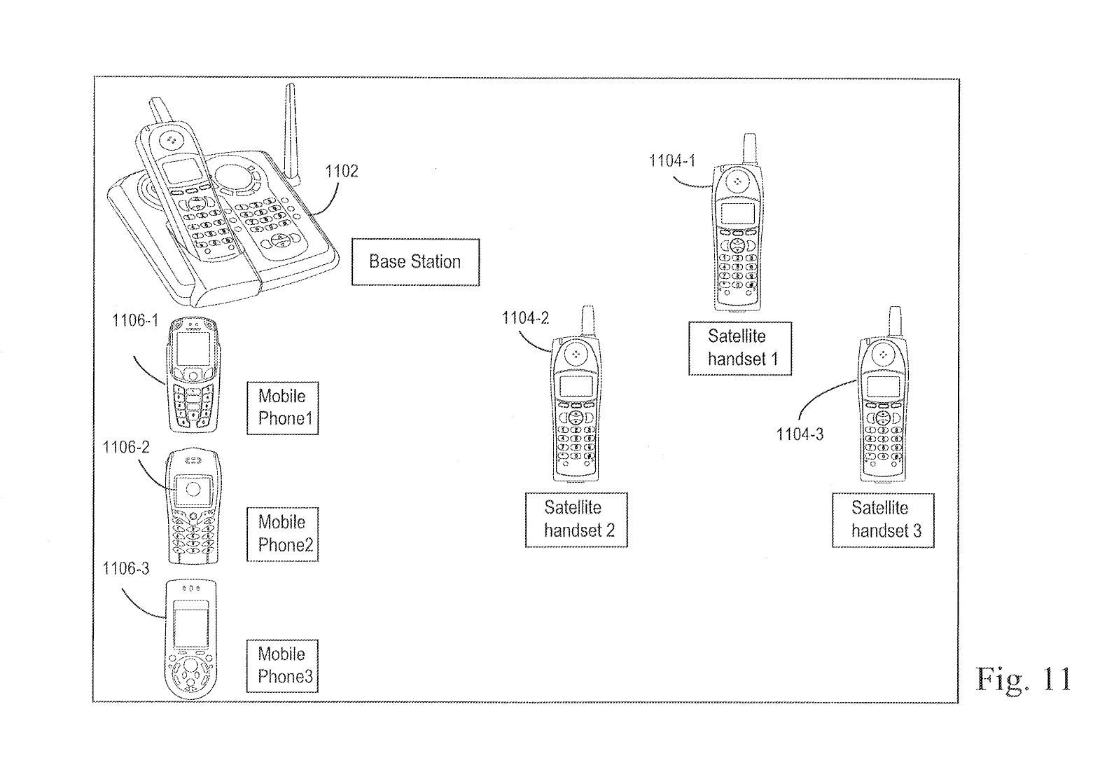

FIG. 11 is a generalized diagram for explaining how wireless calls can be placed and received using the cordless handsets. As will be described in greater detail below, the base station in the FIG. 11 arrangement incorporates interface circuitry like that shown in FIGS. 5 and 6. In addition, mobile phones 1106-1, 1106-2, 1106-3 include the adapter circuitry or incorporate the adapter functionality discussed above with reference to FIGS. 7 and 8. In this way, a wireless communication link between the base station and the mobile phones can be provided.
a. The mobile phones 1106-1, 1106-2, and 1106-3 shown in FIG. 11 are registered to the base station 1102. The registration process may be similar to that described above for registering adapter circuitry 700 to interface circuitry 406.
   a. Once mobiles phones 1106-1, 1106-2, and 1106-3 are registered to base station 1102, any one of the cordless satellite handsets 1104-1, 1104-2, and 1104-3 can be used to place and receive wireless calls in addition to placing and receiving landline telephone calls.
      i. For example: if handset 1104-1 is taken off-hook, the user can dial the number and then base station 1102 determines which mobile phone to use to place the call. The base station determination may be based on pre-stored registration data that registers a particular cordless handset to place and receive calls via a particular mobile phone, or the determination may be based on user input(s) in response to prompts. For example, after the user has dialed a number using cordless handset 1104-1, base station 1102 may send a list of available mobile phones to the handset and the handset may display the list on a display (e.g., CallerID screen) of the handset. Example lists include:
         1. Mobile 1
         2. Mobile 2
         3. Mobile 3
         or
         1. Dad's Mobile
         2. Mom's Mobile
         3. Child 1's Mobile
         The user would then press the appropriate key on the handset to route a placed call via a desired mobile phone.
      ii. As noted above, it is possible to have the cordless satellite handsets each registered to a particular mobile phone. For example, after a cordless handset is registered to base station 1102, the user can associate the handset with a particular mobile phone or with all mobile phones registered to the base station. The registration process can be implemented via display(s) on a display (e.g., CallerID screen) of the handset. For example, if cordless handset 1104-1 is registered to mobile phone 1106-3, then base station 1102 automatically places all outgoing wireless calls from cordless handset 1104-1 via mobile phone 1106-3. In response to an incoming wireless call on mobile phone 1106-3, base station 1102 would ring satellite handset 1104-1.
      iii. It is also possible to register each cordless satellite handsets to one or more of primary, secondary, tertiary, etc. mobile phones. The primary mobile phone would be, for example, the default mobile phone for placing a call from a particular cordless satellite handset; the secondary mobile phone would be used, for example, to place a call from the handset if the primary mobile phone were in use or otherwise not available; the tertiary mobile phone would be used, for example, to place a call from the handset if both the primary and secondary mobile phones were in use or otherwise not available; etc.

In addition, any cordless handset can join a wireless call that is already in progress. For example, if cordless handset 1104-3 is in an ongoing wireless call via mobile phone 1106-2, then another handset can join that conversation. For example, if a user using cordless handset 1104-1 wishes to join a conversation, he/she can invoke a “talk” function by pressing one or more keys associated with this function on the cordless handset 1104-1. The keypress(es) is/are communicated to base station 1102 which then sends a menu to cordless handset 1104-1. The menu may include the following options:
1. Place Landline call
2. Place VoIP call
3. Place cellular call
4. Join call

The menu may be context sensitive so that, for example, the landline call option is not provided if the landline is currently being used for another call and the VoIP option is provided only if the base station is coupled to a VoIP gateway. To join a call, the user would select menu option 4. The base station then forwards another menu to the handset allowing the user to select which call he/she would like to join.

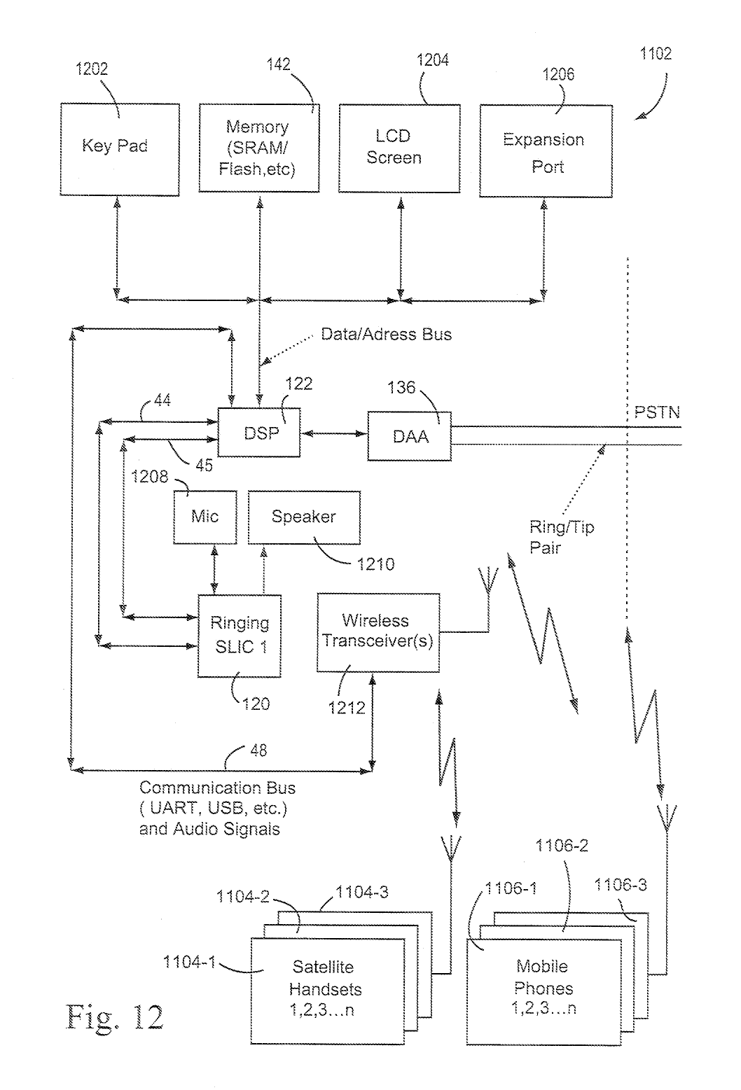

FIG. 12 is a block diagram of the system of FIG. 11 showing an example base station. A description is omitted for the portions of the interface circuitry that are the same as shown in FIG. 6. Base station 1102 includes a keypad 1202, which may include keys corresponding to those on a standard telephone (e.g., number keys (0-9), the # key, and * key). Other function keys for conference call function(s), mute function(s), hold function(s), release line function(s), speakerphone function(s), and registration function(s) may also be provided on keypad 1202. An LCD screen 1204 provides outputs such as current time and date, telephone numbers for incoming and outgoing calls, length of call, and visual prompts associated with the various functions and features described in this application. An expansion port 1206 may be provided to permit, for example, upgrading of the base station with new functions and features. A microphone 1208 detects a speaker's voice and a speaker 1210 permits speakerphone-type operation and may also be used to provide aural prompts associated with the various functions and features described in this application. Wireless transceiver(s) 1212 are provided for wireless communications with cordless satellite handsets 1104-1, 1104-2 and 1104-3 and mobile phones 1106-1, 1106-2 and 1106-3.

As noted above, the memory 42, 142 of the interface circuitry 106, 406 may contain software accessible to DSP 22, 122 for implementing the various functions and features described herein. This software may be built-in at the time of manufacture. Alternatively or in addition, memory 42, 142 may be updateable so that its contents may be modified whereby interface circuitry 106, 406 may be upgraded to provide different or enhanced functions and features. An example of upgrading the contents of memory 42, 142 of interface circuitry 106, 406 is now described, although other techniques may of course be used. For example, interface circuitry 106, 406 may be adapted to accept removable memory media (e.g., semiconductor, magnetic, optical or combinations thereof). Software and data may be copied from such removable memory to flash memory 42, 142 (or may be directly accessed therefrom by DSP 22, 122). The software can be updated via a GPRS internet connection via the mobile phone or a connection to the internet via a Bluetooth-enabled laptop PC or PDA. For example:
a. Updating using General Packet Radio Service (GPRS) wireless protocol (via a mobile phone)
   i. Most mobile phones possess the capability of browsing and receiving information from the Internet using GPRS.
   ii. With this capability, interface circuitry 106, 406 can control the mobile phone to navigate to a particular website and download the upgrade software.
   iii. The downloaded software is sent to interface circuitry 106, 406 and stored, for example, in memory 42, 142 where it is accessible to DSP 22, 122.
      1. This sending of the software to interface circuitry 106, 406 is performed using, for example:
         a. wireless communication such as infrared (IR) communication or Bluetooth communication
         b. wired communication using a cable (e.g., serial, parallel, USB, etc.) connected between the mobile phone and the interface circuitry.

A method of sending data without using a landline connection will be described. This method may be used with the interface circuitry 106 and 406 (along with the interface circuitry associated with the base station of FIG. 12). Although the discussion below is provided in terms of facsimile data, any kind of data can be used. The sending of data can be implemented in several ways as described below.
a. Sending/Receiving facsimiles over the mobile phone network using Circuit Switch Data (CSD).
   i. By utilizing the CSD services provided by Wireless Service Providers (WSP), data can be sent and received over wireless communication network 107 using a wireless communication device 108, 408 such as a PDA, mobile phone, etc.
   ii. One way to implement faxing using CSD is as follows:
      1. A facsimile machine is connected by wire (e.g., an RJ11/serial/parallel cable) or wirelessly to interface circuitry 106, 406. For example, the facsimile machine may correspond to one of the “other devices” 109 shown in FIGS. 1 and 4. This connection allows interface circuitry 106, 406 to detect when the facsimile machine is “on/off hook”, “dialing”, “sending/receiving data”, and performing other facsimile/telephone functions.
      2. All information received by interface circuitry 106, 406 from the facsimile machine is communicated to, for example, a CSD-enabled mobile phone, which will in turn place a “Fax” or “Data” call using the wireless communication network 107.
      3. A detailed description of the above is as follows:
         a. Assumptions:
            i. A mobile phone (e.g., mobile phone 108, 408, 1106-2), which subscribes to CSD service from a WSP, is connected to interface circuitry 106, 406 or the interface circuitry in FIG. 12 via Bluetooth, 802.11, serial/USB cable, infrared (IR), etc.
            ii. A facsimile machine is connected to interface circuitry 106, 406 (or the interface circuitry in FIG. 12) by wire (e.g., a RJ11, serial/parallel cable etc.) or wirelessly
         b. Sending a Fax
            i. When the facsimile machine goes off-hook, the interface circuitry detects the off-hook signal and waits until data is sent from the facsimile machine.
            ii. As the interface circuitry receives the facsimile data (e.g., facsimile number and actual facsimile data) from the facsimile machine, the interface circuitry relays this data to the mobile phone.
            iii. Upon receiving the data from the facsimile machine (via the interface circuitry), the mobile phone places a facsimile call.
            iv. Once the destination facsimile machine goes off hook in response to the incoming call, a communication link is established between the two (i.e., the sending and the destination) facsimile machines.
         c. Receiving a Fax
            i. When a mobile phone (e.g., mobile phone 108, 408, 1106-2) receives an incoming facsimile call, it sends a signal to the interface circuitry.
            ii. The interface circuitry in turn rings the facsimile machine connected (by wire or wirelessly) thereto.
            iii. When the facsimile machine goes off-hook, the interface circuitry detects this state and commands the mobile phone to answer the incoming call.
            iv. When the incoming call is answered, the mobile phone sends the facsimile data to the interface circuitry which in-turn relays the facsimile data to the facsimile machine.

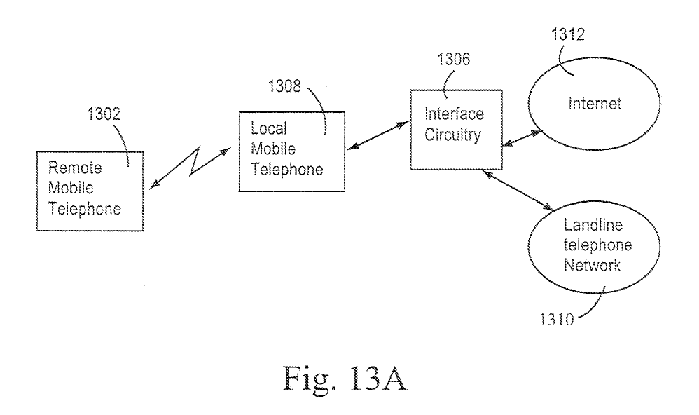

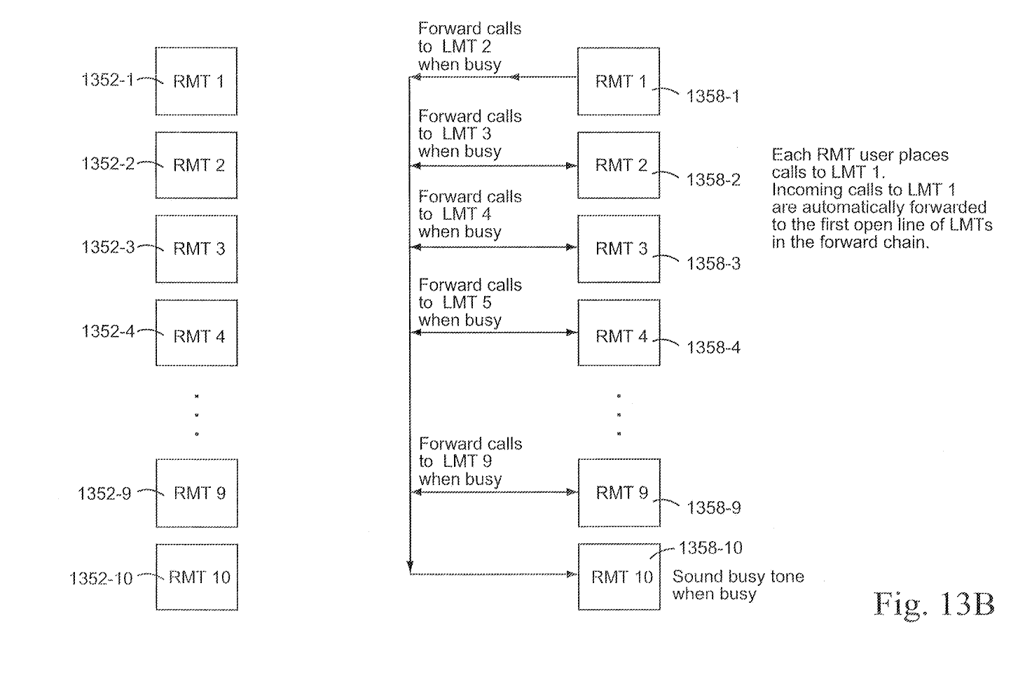

The communication systems described herein can be adapted to route audio and data over different communication networks. FIG. 13A shows an example communication system providing this capability which permits, for example, internet and/or landline calls may be placed and received by a remote mobile telephone. The elements of FIG. 13A include:
1. Remote Mobile telephone (RMT): Mobile telephone 1302 is remote with respect to the interface circuitry 1306 shown in FIG. 13A. RMT 1302 is connected to a WSP.
2. Local Mobile telephone (LMT): Mobile telephone 1308 is local with respect to the interface circuitry 1306 shown in FIG. 13A. LMT 1308 has a communication channel (wired or wireless) established with the interface circuitry 1306. This communication channel can be WiFi, Bluetooth, infrared, USB, serial port, cable connection or other known connection methods. LMT 1308 is also connected to a WSP. If a wireless link is provided between LMT 1308 and interface circuitry 1306, it may be (but is not limited to) a short-distance (e.g., less than about 150 meters) wireless link.
3. Interface Circuitry: Interface circuitry 1306 may be, for example, the interface circuitry described in connection with FIGS. 2A-2C and 5-7 or used in the base station of FIG. 12. In the example implementation of FIG. 13A, interface circuitry 1306 is connected to the landline telephone network 1310 and to the Internet 1312.

The system of FIG. 13A permits audio and data to be routed over different communication networks. Examples of how this is accomplished are as follows:
1. Routing outgoing telephone calls from RMT 1302 over a landline.
   a. RMT 1302 places a call to the LMT 1308.
   b. LMT 1308 detects the incoming call, optionally checks the caller ID to ensure authenticity, and signals interface circuitry 1306 of the incoming call via the communication interface therebetween (e.g., WiFi, Bluetooth, infrared, USB, etc as noted above).
   c. Interface circuitry 1306 instructs the LMT 1308 to accept the incoming call.
      i. Result: RMT 1302 is now connected to the LMT 1308 via the mobile phone network
   d. Interface circuitry 1306 accesses the landline telephone network 1310 and conferences the landline to the incoming call from RMT 1302 via LMT 1308. A communication path now exists between RMT 1302 and the landline telephone network 1310.
      i. Result: RMT 1302 now receives a dial tone
   e. RMT 1302 now dials the telephone number of the called party (e.g., in response to user button presses).
   f. Landline telephone network 1310 receives the button presses from RMT 1302 and places the call over the landline network 1310.
      i. Result: Call is connected
   g. If RMT 1302 terminates the ongoing call, LMT 1308 signals interface circuitry 1306 and interface circuitry 1306 terminates the call on the landline network 1310.
2. Routing outgoing telephone calls from RMT 1302 over the Internet.
   a. RMT 1302 places a call to LMT 1308.
   b. LMT 1308 detects the incoming call, optionally checks the caller ID to ensure authenticity, and signals interface circuitry 1306 of the incoming call via the communication interface therebetween (WiFi, Bluetooth, infrared, USB, etc. as noted above).
   c. Interface circuitry 1306 instructs LMT 1308 to accept the incoming call.
      i. Result: RMT 1302 is now connected to LMT 1308 via the mobile phone network
   d. Interface circuitry 1306 accesses the Internet 1312 and creates a communication channel between the Internet 1312 and RMT 1302 via LMT 1308.
      i. Result: RMT 1302 is prompted with a voice prompt that instructs the user of RMT 1302 to dial the number of a called party.
   e. Interface circuitry 1306 detects the DTMF button presses and routes the call over the Internet 1312 using VoIP or some similar protocol.
      1. Result: Call is connected
   f. If RMT 1302 terminates the ongoing call, LMT 1308 signals interface circuitry 1306 and interface circuitry 1306 terminates the VoIP call.
3. Routing incoming landline and/or VoIP calls over the mobile phone network to RMT 1302.
   a. An incoming landline telephone call is received at the number that is associated with the landline that is connected to interface circuitry 1306. In other implementations, the interface circuitry may be connected for receiving VoIP calls (including peer-to-peer VoIP calls using, for example, Skype or Yahoo!® Messenger).
      i. Result: Interface circuitry 1306 detects incoming calls
   b. Interface circuitry 1306 instructs LMT 1308 to place a call to RMT 1302
      i. Result: a communication channel is established between RMT 1302 and LMT 1308.
   c. Interface circuitry 1306 establishes a communication link (e.g., a 3 way conference call) between the incoming landline and/or a VOIP call to RMT 1302 via LMT 1308.
   d. If the RMT 1302 terminates the ongoing call, LMT 1308 signals the interface circuitry 1306 and interface circuitry 1306 terminates the landline and/or VOIP call.

In the current mobile phone service market place, consumers and businesses can obtain wireless mobile phone service with unlimited mobile-to-mobile calls for a relatively small monthly fee (e.g., $34.99/month). Because of this, it is possible to purchase two mobile phone service plans to obtain two mobile phones. In this case, one of the mobile phones (LMT 1308 in this case) can remain in a fixed location (e.g., home, office, etc.) and be connected to interface circuitry 1306 via a wired or wireless communication path. Interface circuitry 1306 can be connected to an internet connection 1312 and/or a landline telephone network 1310. The second mobile phone (RMT 1302 in this case) is mobile and can then be used to place wireless calls to LMT 1308, which as noted, is connected to interface circuitry 1306. Interface circuitry 1306 can then route any incoming calls to LMT 1308, for example, over the Internet 1312, resulting in a free call. Thus, with the FIG. 13A arrangement, it is possible for the user of RMT 1302 to place and receive wireless calls over the Internet 1312, resulting in a free call.

Existing systems require the mobile service operators to invest huge amounts of money in capital equipment that cost in the millions of dollars. With the FIG. 13A arrangement, mobile phone operators are only required to purchase new customer premises equipment that costs a few hundred dollars each.

In addition, the FIG. 13A arrangement does not require any participation of the mobile operator. Consumers can purchase and use the product without any intervention of their mobile phone service provider.

The arrangement of FIG. 13A is readily extendible to multiple RMTs and LMTs. An example system providing such extendibility is shown in FIG. 13B which illustrates ten LMTs 1358-1, 1358-2, . . . , 1358-10. Each of these LMTs is connected to interface circuitry and the internet and/or a landline in a manner similar to LMT 1308 in FIG. 13A. The LMTs of FIG. 13B are arranged so that if LMT 1358-1 is busy when there is an incoming call from one of RMTs 1352-1, 1352-2, . . . , 1352-10, the call will automatically be forwarded to LMT 1358-2. If LMT 1358-2 is busy, the call is forwarded to LMT 1358-3 and so on. If the call is forwarded from LMT 1358-9 to LMT 1358-10 and LMT 1358-10 is busy, the calling RMT receives a busy signal. In the configuration of FIG. 13B, users of the RMTs only need a single call-in number for LMT 1358-1 and at least ten users can use the LMTs concurrently. Of course, the number of LMTs need not be the same as the number of RMTs and more or fewer than ten LMTs and RMTs may be used. Landline and/or VoIP calls to LMT 1358-1 can be similarly forwarded to other LMTs for handling (e.g., by calling an RMT) depending, for example, on which LMTs are already engaged in calls.

As described above and in the prior application Ser. No. 10/615,408, the interface circuitry (e.g., interface circuitry 106, 406, and the interface circuitry incorporated in the base station of FIG. 12) is able to display Caller ID information to a telephone or telephone-like device during an incoming wireless call from a mobile phone or similar device. For example, during an incoming wireless call, the mobile phone transmits the number of the calling party to the interface circuitry, and the interface circuitry in turn displays this number on a Caller ID-enabled landline telephone.

Because the interface circuitry stores names and telephones numbers associated with contacts in its resident memory (e.g., memory 42, 142), it is possible to display not only the number associated with an incoming wireless call, but also a name associated with the number as well. One possible implementation of such a method is as follows:
i. During an incoming wireless call, the wireless phone does the following:
   1. Sends an “incoming call” message to interface circuitry 106, 406 or the interface circuitry in FIG. 12
   2. Sends the number of the calling party to the interface circuitry
      ii. Upon receiving the “incoming call” message the interface circuitry does the following.
         1. Goes into “incoming call” mode
         2. Compares the received caller ID number with the numbers stored in memory.
            a. If a match is found, then the name associated with the matched number is displayed with the number.
            b. If a match isn't found, then just number is displayed as normal.

The interface circuitry described herein may be used so that a mobile phone may place and receive calls using, for example, Bluetooth wireless technology and a Bluetooth-enabled access point. It is desirable to allow a mobile phone user to place and receive calls using Bluetooth technology via a Bluetooth-enabled access point that is connected to a landline or VoIP gateway. Generally, attempts to provide such functionality have required that the Bluetooth-enabled mobile phone support the Cordless Telephony Profile (CTP).

Once developed and implemented, such functionality could allow consumers to use a mobile phone to place and receive calls, even in areas where no cellular reception exists. Indeed, the mobile phone could be used to place and receive call even if the mobile phone does not have cellular service with a wireless carrier such as Cingular Wireless, T-Mobile, etc. With this functionality, a consumer would only need to use one device (i.e., a mobile phone) to place and receive all calls. Outdoors, the mobile phone can be used normally to place and receive calls via a wireless communication network using, for example, a wireless carrier such as Cingular or T-Mobile. Indoors, the mobile phone could function as a landline or a VoIP telephone, but still retain its cellular capabilities.

The Bluetooth CTP profile would allow a mobile phone to behave like a fixed line telephone when the mobile phone is within range of a Bluetooth access point that also supports the CTP profile. However, no mobile phones currently support the CTP profile and thus such products have not been marketed.

The following describes a method of implementing the CTP functionality without the mobile phone supporting the CTP profile. The solution consists of installing a small client application on the mobile phone and having the application communicate via Bluetooth to a Bluetooth enabled access point.

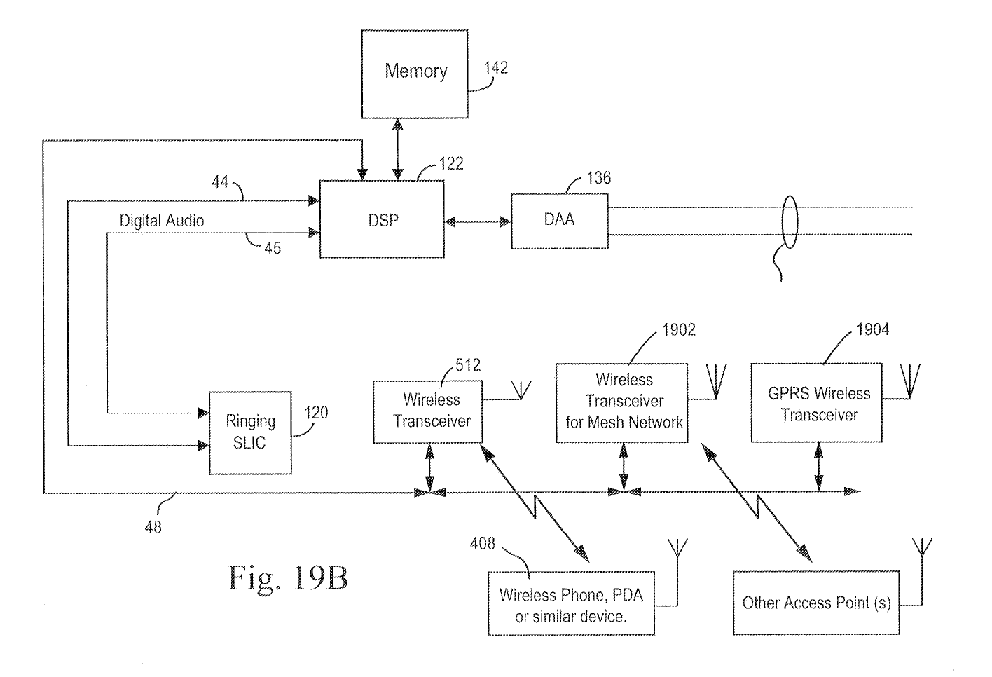

A description of an example technique for such an implementation follows:
I. One or more Bluetooth links (e.g., serial) are established between a Bluetooth-enabled mobile phone and a Bluetooth-enabled access point. Example access points 1900 are shown in FIGS. 19A and 19B. The access point in FIG. 19A includes interface circuitry along the lines shown in FIG. 2A connected to a wireless transceiver 512, a wireless transceiver 1902 for a mesh network, and a GPRS wireless transceiver 1904. Wireless transceiver 512 permits communication with, for example, a wireless device such as a Bluetooth-enabled mobile phone and wireless transceiver 1902 permits communication with other access points in a mesh network (to be discussed in greater detail below). The access point in FIG. 19B includes interface circuitry along the lines shown in FIG. 2C connected to a wireless transceiver 512, a wireless transceiver 1902 for a mesh network and a GPRS wireless transceiver 1904. Other access points such as those available from Axis Communications may also be used. Although FIGS. 19A and 19B show the access points as being connected to the landline telephone network, some or all of the access points may not have such a connection. In addition, GPRS wireless receiver 1904 may be omitted from some or all of the access points.
   a. If two links are used, the first link may be used for sending audio data and control commands from the access point to the mobile phone and the second link may be used to send audio data and control commands to the access point from the mobile phone.
   b. A single bi-directional link may also be used.
II. An application within the mobile phone samples and compresses the audio using a standard audio compression algorithm(s). The application providing this functionality may be delivered to the mobile phone using MMS, SMS with attachment, USB cable, serial cable, Bluetooth connection, infrared connection, etc.
   a. Once compressed, the audio is buffered and sent from the mobile phone over the Bluetooth link to the access point.
      i. The access point receives the compressed data, places it in a buffer, decompresses it (e.g., in real time), and sends the decompressed audio over the landline or over the Internet as VoIP (via a VoIP gateway).
   b. The transmission packet from the mobile phone to the access point also contains a reserve space for any control commands. This allows the mobile phone to send control commands to the access point while audio is being communicated between the two units.
III. Similar operations occur occurs for audio transmissions (e.g., arising from the landline or VoIP) from the access point to the mobile phone.
IV. To address potential audio quality of service problems, the access point and/or the mobile phone may use telephony algorithms such as:
   a. real time echo canceling
   b. automatic gain control
   c. comfort noise generator
   d. DTMF detection and generation
   e. Caller ID detection and generation

The above example can also be implemented between two or more mobile phones, personal computers, PDAs and other equipment.

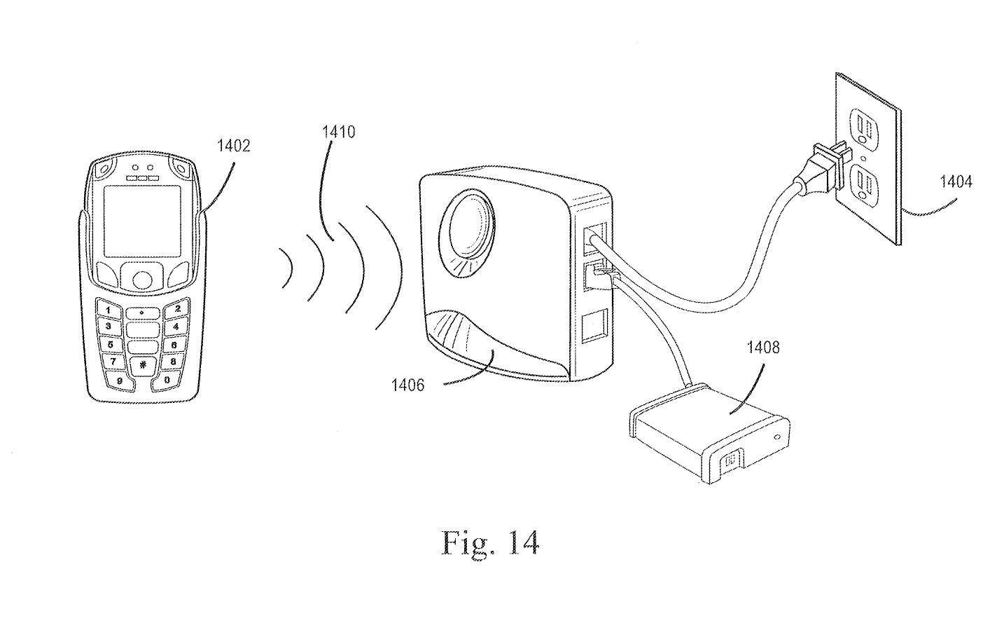

FIGS. 14-16 provide illustrative examples of implementations in which an access point is connected, for example, to a landline or a VoIP gateway. In these examples, the access point need not include a wireless transceiver for a mesh network or a GPRS wireless transceiver, although these components may be provided if desired.

FIG. 14 shows a mobile phone 1402, which is in communication with access point 1406 over a Bluetooth link 1410. Access point 1406 is configured, for example, along the lines of the access point illustrated in FIGS. 19A and 19B. Access point 1406 is powered via a connection with a wall socket 1404 and is connected to a VoIP gateway 1408. In this arrangement, a Bluetooth-enabled mobile phone 1402 can be used to place and receive VoIP calls in a home or office setting. Thus, access point 1406 functions as a VoIP access point that allows a user to place and receive VoIP calls using Bluetooth directly from a mobile phone without using wireless minutes.

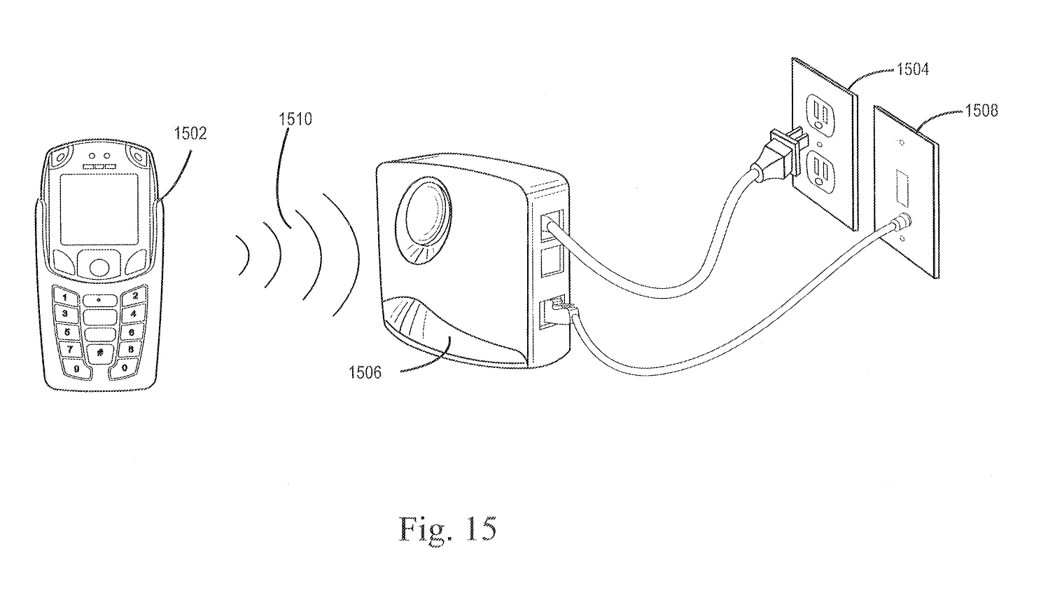

FIG. 15 shows a mobile phone 1502, which is in communication with access point 1506 over a Bluetooth link 1510. Access point 1506 is configured, for example, along the lines of the access point illustrated in FIGS. 19A and 19B. Access point 1506 is powered via a connection with a wall socket 1504 and is connected to a landline telephone network via jack 1508. In this arrangement, a Bluetooth-enabled mobile phone 1502 can be used to place and receive landline calls in a home or office setting. Thus, access point 1506 functions as a landline network access point that allows a user to place and receive landline calls using Bluetooth directly from a mobile phone without using any wireless minutes. Thus, a user may make calls from a mobile phone even if there is no cellular reception.

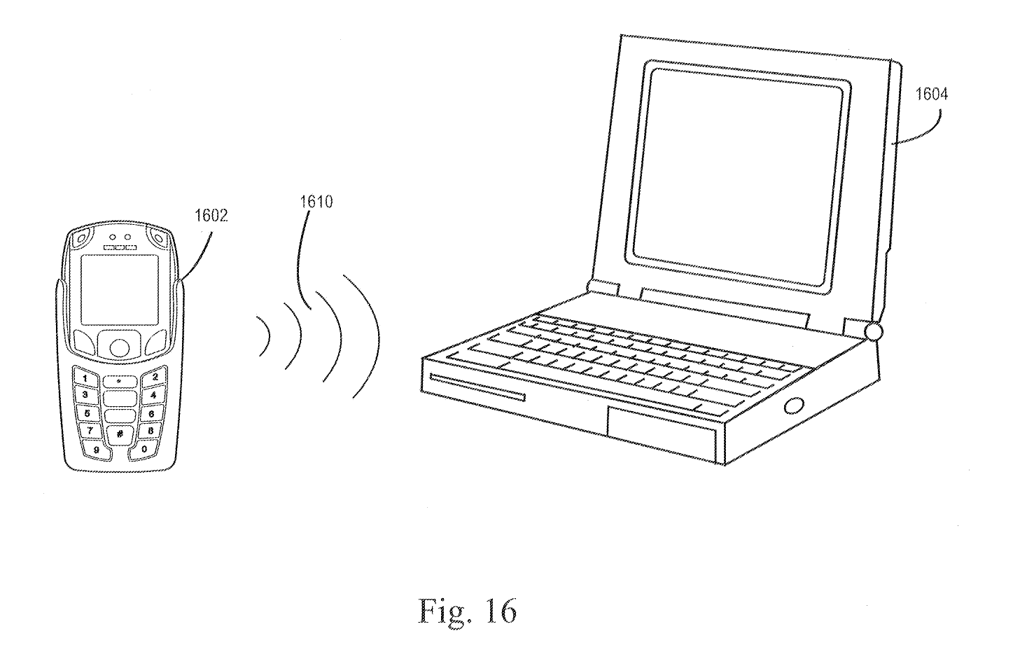

FIG. 16 shows a mobile phone 1602, which is in communication with a computer 1604 over a Bluetooth link 1610. The computer is running a program (e.g., Skype available from Skype Technologies SA) that permits Internet calls to be placed. In this arrangement, access point software interfaces directly with the Internet call program and allows a user to place and receive calls from the mobile phone using Bluetooth. Thus, a user can make calls from a mobile phone even if there is no cellular reception and without using any wireless minutes. Because the access point is connected to a landline or a VoIP gateway (or is running on a computer as a software application), the access point samples the incoming audio, for example, from the landline, compresses it, and communicates it to the mobile phone. Buffering is used in both the mobile phone and the access point to address potential quality of service issues.

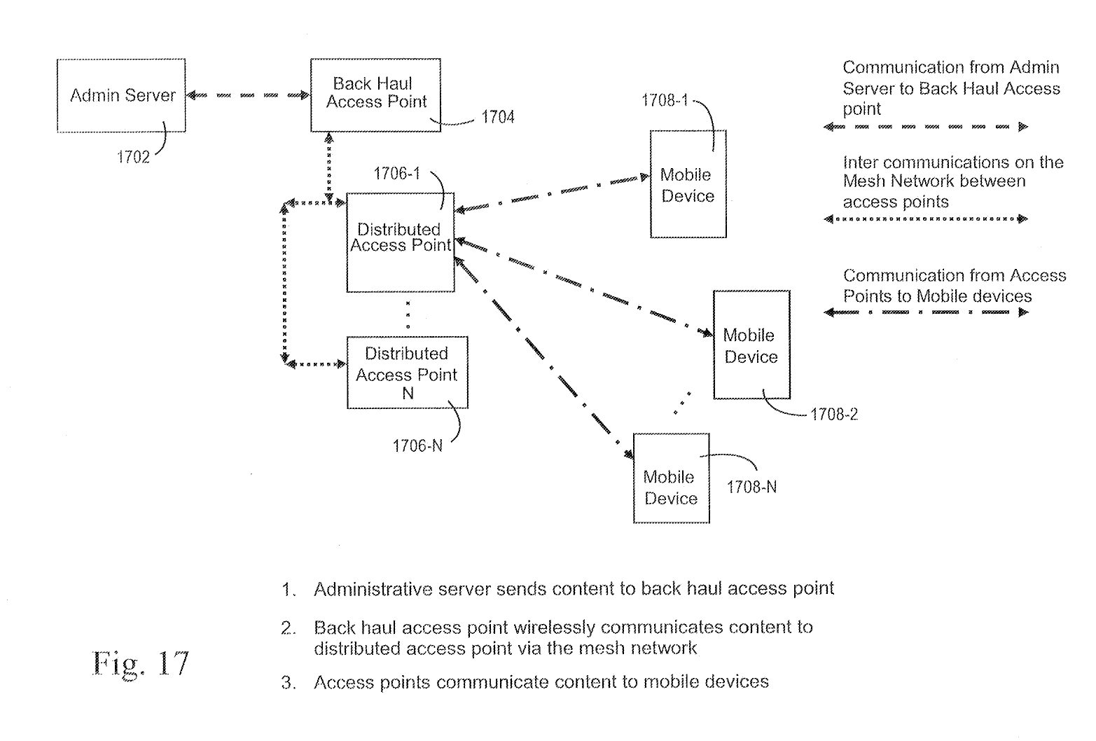

FIG. 17 will be used to describe an implementation in which content (including, but not limited to, advertisements) is sent to a Bluetooth-enabled mobile phone via a Bluetooth-enabled access point. Specifically, content may be sent to mobile phones 1708-1, 1708-2, . . . 1708-N using at least one Bluetooth-enabled access point 1706. Multiple access points 1706 may be distributed throughout a city, community, town, etc. by mounting them on poles, buildings and the like. In other implementations (particularly in large cities), some access points may be mounted on vehicles such as buses and taxicabs.

The access points 1706-1, . . . 1706-N communicate with each other wirelessly from distances that may range from about one foot up to one or more miles. The access points are designed in such a way that each access point forms a node on a wireless mesh network, and thus allows messages and data to be sent between each node and/or from a central location to allow for updating the access points with new content or the downloading of information logs from each or all nodes on the network. Generally speaking, mesh networking enables data to be routed between nodes. Each node need only transmit as far as the next node and the nodes function as repeaters to transmit data from nearby nodes to far away nodes. Because each node is typically connected to two or more other nodes, data can be routed around non-functioning nodes. Various protocols may be used for transmitting data over mesh networks including TORA (Temporally-Ordered Routing Algorithm) and OORP (OrderOne Routing Protocol). Custom designed protocols may also be used. One particular type of mesh network is described in provisional Application No. 60/673,759, the contents of which are incorporated herein.

Because wireless protocols such as Bluetooth require a registration process known as “pairing” to establish a communication link with another Bluetooth device, each mobile phone is required to pair with each and every access point (which could number in the hundreds or thousands). More specifically, in a pairing process, the mobile phone searches for discoverable Bluetooth-enabled access points in the area. Of course, in other situations, the access point may search for discoverable mobile phones. During this process, discoverable access points broadcast device information that identifies a device type (e.g., access point) and a device name. When the mobile phone detects a discoverable device, passkeys or identifiers must be exchanged between the mobile phone and the discoverable device in order to pair the mobile phone with the device. However, such pairing with each and every access point is impractical for a real world implementation.

One solution to this problem is to provide each access point 1706 with the same Bluetooth serial number ID (Bluetooth Address). In this case, the mobile phone would only need to pair with one of the access points. Although there might potentially be thousands of access points distributed within a certain area, from the mobile phone's point of view, each access point would be the same because all the access points have the same Bluetooth ID.

Within a certain area, a certain percentage of the access points is typically connected to a backhaul access point 1704 such as a landline telephone network, a wireless General Packet Radio Service (GPRS) network, etc. The backhaul access point is physically the same as the access points shown in FIGS. 19A and 19B, but is connected to a landline or internet connection (or includes a GPRS transceiver) that allows it to communicate to the administrative server. For example, back haul access point 1704 may be connected to the internet and this allows an administration server 1702 to send new content or system commands to back haul access point 1704. Once back haul access point 1704 receives new information from the administration server 1702, the back haul access point 1704 broadcasts the message/content to access points 1706 that are on the mesh network.

An example of how an entire system would work follows.
I. A user downloads a client application to his/her mobile phone that allows the mobile phone to wirelessly communicate with the access point.
   a. The application could be delivered, for example, over the mobile telephone network by Multimedia Message Service (MMS), e-mail, data cable, Bluetooth, etc.
II. The access points 1706-1, . . . , 1706-N continuously search for Bluetooth-enabled devices
   a. When an access point 1706 finds a Bluetooth-enabled device (e.g., a mobile device 1708), it attempts to establish a Bluetooth connection.
      i. once a Bluetooth connection is established, access point 1706 sends an encrypted authentication message to mobile device 1708. If the particular mobile device 1708 is running the client application, then it responds with an authentication code. Once the code is accepted by access point 1706, the following occurs:
         1. Access point 1706 queries the application for the following info:
            a. Version (revision) of software
            b. List of contents in mobile device memory
            i. Contents type
            ii. Content date
            c. User application settings.
         2. Access point 1706 determines whether to send any new content to mobile device 1708 running the application based on the information received during the initial query
            a. Content is sent to mobile device 1708 and the application outputs (e.g., displays) this content based on the settings that are embedded within the content and/or the user settings for the application.
         3. Access point 1706 stores the content that was sent to the mobile device 1708 and the ID number of mobile device 1708. This information is encrypted within the memory of the access point 1706. More specifically, this information is stored in the flash memory of the access point and is periodically updated by the administrative server via the back haul unit.
         4. On a time slot basis, each access point 1706 communicates a log file back to an administrative server 1702 via back haul access point 1704 for permanent storage.
         5. Administrative server 1702 has the ability to query any of the access points 1706 at any time and update each or all of the access points 1706 with new content.

As described above, the interface circuitry is operable is various modes to provide a number of advantageous features to users. The interface circuitry may be configured for a particular mode at the time of manufacture or the interface circuitry may be configurable “in the field” for particular mode(s). “In the field” configurations may be carried out using any of the devices connected to the interface circuitry. For example, configuration software running on a computer, laptop, PDA, mobile phone or similar device may be used to send configuration data (by wired or wireless communication link) to the interface circuitry.

While the invention has been described in connection with certain embodiments, it is to be understood that the invention is not to be limited to the disclosed embodiment, but on the contrary, is intended to cover various modifications and equivalent arrangements.

I claim:

1. A system comprising:
one or more handsets; and
a base unit including interface circuitry configured for landline communication over a telephone network landline, wireless communication with the one or more handsets and wireless communication with one or more cellular telephones, each of the one or more cellular telephones being adapted for communication over a cellular telephone network,
wherein the interface circuitry is further configured to allow the handsets to make or receive landline or cell phone calls.

2. The system according to claim 1, wherein the handsets output caller identification information for received calls.

3. The system according to claim 2, wherein the handsets comprise a display for displaying the caller identification information.

4. The system according to claim 3, wherein the display displays a list comprising one or more of the cellular telephones available to make a call.

5. The system according to claim 4, wherein the handsets further comprise an input device for selecting one of the cellular telephones from the list and wherein the interface circuitry is responsive to the selecting to make the call using the selected cellular telephone.

6. The system according to claim 1, wherein the interface circuitry is incorporated into a base unit.

7. The system according to claim 6, wherein the base unit comprises a keypad.

8. The system according to claim 6, wherein the base unit comprises a display.

9. The system according to claim 1, wherein the cellular telephones are paired with the interface circuitry.

10. The system according to claim 1, wherein the cellular telephones are Bluetooth-paired with the interface circuitry.

11. A system comprising:
two or more handsets; and
a base unit including interface circuitry comprising one or more wireless transceivers for wireless communication with the two or more handsets and wireless communication with two or more cellular telephones each paired with the interface circuitry, each of the cellular telephones being adapted for communication over a cellular telephone network,
wherein the interface circuitry further comprises processing circuitry configured to allow each of the handsets to make or receive cell phone calls.

12. The system according to claim 11, wherein the handsets are configured to allow cellular telephone selection and the interface circuitry makes cell phone calls in accordance with the selection.

13. The system according to claim 11, wherein the handsets output caller identification information for received calls.

14. The system according to claim 13, wherein the handsets comprise a display for displaying the caller identification information.

15. The system according to claim 14, wherein the display displays a list comprising one or more of the cellular telephones available to make a call.

16. The system according to claim 11, wherein the base unit comprises a keypad.

17. The system according to claim 11, wherein the base unit comprises a display.

18. A system for providing content to a wireless mobile communication device, comprising:
a plurality of wireless access points each assigned the same identifier;
a wireless mobile communication device paired to the wireless access points using the identifier, wherein
the access points are configured to send content to the mobile wireless communication device.

19. The system according to claim 18, wherein the content comprises advertising.

20. The system according to claim 18, wherein the wireless access points are arranged in a wireless mesh network.
